(19) United States
(12) Patent Application Publication
(10) Pub. No.: US 2026/0073478 A1
(43) Pub. Date: Mar. 12, 2026

(54) TECHNIQUE FOR ADJUSTING DISTORTION OF FIELD OF VIEW FOR CAMERA IN INTELLIGENT TRANSPORTATION SYSTEMS

(71) Applicant: NOTA, INC., Daejeon (KR)

(72) Inventors: Minseong KO, Daejeon (KR); Hwanhyo PARK, Daejeon (KR); Dongho KA, Daejeon (KR); Jungryul KIM, Daejeon (KR); Haejin LEE, Daejeon (KR)

(73) Assignee: NOTA, INC., Daejeon (KR)

(21) Appl. No.: 19/307,373

(22) Filed: Aug. 22, 2025

(30) Foreign Application Priority Data
Sep. 9, 2024 (KR) 10-2024-0122391
Oct. 31, 2024 (KR) 10-2024-0151772

(51) Int. Cl. G06T 5/50; G06T 5/60; G06T 5/70; G08G 1/097; H04N 23/58

(52) U.S. Cl. CPC G06T 5/50; G06T 5/60; G06T 5/70; G08G 1/097; H04N 23/58; G06T 2207/10016; G06T 2207/30232; G06T 2207/30236

(57) ABSTRACT

The method for adjusting a distortion of a field of view of a camera in an intelligent transportation system comprises: receiving a target image, generating a first extraction result by extracting a predefined target object within the target image and a second extraction result by extracting the target object within a reference image, determining whether a distortion of the field of view of the target camera exists, using a first comparison result between the first extraction result and the second extraction result and a predefined threshold, determining a distortion type of the field of view of the target camera, using the first comparison result, when the distortion of the field of view of the target camera exists, and adjusting the distortion of the field of view of the target camera by using a different field of view adjustment scheme according to the distortion type of the target camera.

### CROSS-REFERENCE TO RELATED APPLICATIONS

This application claims priority to and the benefit of Korean Patent Application No. 10-2024-0122391 filed in the Korean Intellectual Property Office on 9 Sep. 2024, and Korean Patent Application No. 10-2024-0151772 filed in the Korean Intellectual Property Office on 31 Oct. 2024, the entire contents of which are incorporated herein by reference.

### TECHNICAL FIELD

This disclosure relates to intelligent transportation systems, and more specifically, to a technique for adjusting distortion of field of view (FOV) for camera in intelligent transportation systems.

### BACKGROUND ART

An Intelligent Transportation System (ITS) refers to a system that utilizes various information and communication technologies to improve the efficiency, safety, and convenience of transportation. In such an intelligent transportation system, a camera can serve as an important sensor that detects road conditions and traffic conditions and collects data. Through the camera, the intelligent transportation system can analyze traffic flow, prevent traffic accidents, and monitor vehicle speed or parking spaces.

In an intelligent transportation system, a case where the camera's angle of view or field of view becomes misaligned or distorted may occur according to the installation environment or physical conditions of the camera. The distortion of the field of view refers to a phenomenon in which an image is captured while deviating from an original angle due to the camera physically moving from the location where it is installed, or due to vibration and external impact. In a case where a distortion of the field of view occurs, the camera becomes unable to provide a proper image. The distortion of the field of view degrades the accuracy of the image collected by the camera, and as a result, it can affect the performance of the intelligent transportation system. A distorted image according to such distortion causes an error in various traffic-related analyses such as object recognition, distance measurement, and speed calculation within the intelligent transportation system.

As a technology for detecting a distortion of a field of view, mechanical sensor-based technologies using a gyroscope or an accelerometer can exist. For example, a gyroscope attached to the camera can measure an angular change of the camera and, in a case where the measured angular change exceeds a specific threshold value, can determine that a distortion of the camera's field of view has occurred. Furthermore, as a technology for detecting a distortion of a field of view, an image processing-based technology that detects whether or not a distortion of the camera's field of view has occurred by analyzing an image acquired through the camera via an image processing technology may exist.

Korean Patent Publication No. 10-2073482 can be considered prior art.

### SUMMARY OF THE INVENTION

Technical objects of the present disclosure are not restricted to the technical object mentioned above. Other unmentioned technical objects will be apparently appreciated by those skilled in the art by referencing the following description.

According to an embodiment of the present disclosure, a method for adjusting a distortion of a field of view of a camera in an intelligent transportation system is disclosed. The method performed by a computing device, comprises: receiving a target image captured by a target camera, generating a first extraction result by extracting a predefined target object within the target image from the target image, and generating a second extraction result by extracting the target object within a reference image from the reference image assigned to the target camera, generating a first comparison result between the first extraction result and the second extraction result, determining whether a distortion of the field of view of the target camera exists, using the first comparison result and a predefined threshold, when it is determined that the distortion of the field of view of the target camera exists, determining a distortion type of the field of view of the target camera, using the first comparison result, and adjusting the distortion of the field of view of the target camera by using a different field of view adjustment scheme according to the distortion type of the target camera.

According to an embodiment of the present disclosure, the method further comprises: receiving a plurality of sample images captured by the target camera, generating verification results corresponding to the plurality of sample images, by using one sample image of the plurality of sample images and the remaining sample images other than the one sample image among the plurality of sample images, wherein one verification result is generated for one sample image, and determining the reference image corresponding to the target camera among the plurality of sample images, by using the verification results.

According to an embodiment of the present disclosure, the generating of the verification results comprises: generating third extraction results by extracting the target object from each of the plurality of sample images, using an artificial intelligence model to which each of the plurality of sample images is input, and generating the verification results corresponding to the plurality of sample images by calculating, for each of the plurality of sample images, a distortion magnitude with other sample images, in a manner of comparing one extraction result corresponding to one sample image among the third extraction results with each of the remaining extraction results corresponding to the remaining sample images other than the one sample image.

According to an embodiment of the present disclosure, the determining of the reference image among the plurality of sample images by using the verification results comprises: determining a sample image corresponding to a verification result with the smallest distortion magnitude among the verification results as the reference image corresponding to a region of interest (ROI) of the target camera.

According to an embodiment of the present disclosure, among the third extraction results, sample images having an extraction result where a ratio of an area occupied by the target object within the image is smaller than a predetermined threshold ratio are excluded from the generating the verification results.

According to an embodiment of the present disclosure, the generating of the first comparison result between the first extraction result and the second extraction result comprises: detecting target feature points from the first extraction result and detecting reference feature points from the second extraction result, and generating the first comparison result including first transformation information that represents a distortion between the target image and the reference image, by matching the target feature points and the reference feature points. Wherein the determining of whether the distortion of the field of view of the target camera exists comprises, determining that the distortion of the field of view of the target camera exists, when the first transformation information is greater than the predefined threshold. Wherein the determining of the distortion type of the field of view of the target camera using the first comparison result comprises, determining the distortion type of the field of view of the target camera based on the first transformation information.

According to an embodiment of the present disclosure, the determining of the distortion type of the field of view of the target camera based on the first transformation information comprises: generating a restored target image by applying a transformation matrix included in the first transformation information to the target image so that the target image is matched to the reference image, and determining the distortion type of the field of view of the target camera, by using the restored target image.

According to an embodiment of the present disclosure, the determining of the distortion type of the field of view of the target camera by using the restored target image comprises, determining whether the distortion type of the field of view of the target camera is a first type corresponding to a large distortion or a second type corresponding to a small distortion, by using a size of a noise region generated in a process of restoring the target image within the restored target image.

According to an embodiment of the present disclosure, the determining of the distortion type of the field of view of the target camera by using the restored target image comprises: obtaining a region of interest set for the target camera, and determining whether the distortion type of the field of view of the target camera is a first type corresponding to a large distortion or a second type corresponding to a small distortion, based on whether an overlapping portion exists between the obtained region of interest and a noise region generated in a process of transforming the target image.

According to an embodiment of the present disclosure, the method further comprises: determining a pixel accuracy for the restored target image by comparing, at a pixel level, a first pixel set representing the target object in the restored target image and a second pixel set representing the target object in the reference image, and evaluating a restoration accuracy of the restored target image by using the pixel accuracy.

According to an embodiment of the present disclosure, a method further comprises: detecting restored target feature points representing the target object in the restored target image and detecting the reference feature points from the second extraction result, generating a second comparison result including second transformation information that represents a distortion between the restored target image and the reference image, by matching the restored target feature points and the reference feature points, and evaluating a restoration accuracy of the restored target image by using the second transformation information.

According to an embodiment of the present disclosure, the distortion type includes a first type corresponding to a large distortion and a second type corresponding to a small distortion. The adjusting of the distortion of the field of view of the target camera comprises: evaluating a restoration accuracy of the restored target image when the distortion type is determined as the second type, and adjusting the distortion of the field of view of the target camera by replacing the target image with the restored target image, when the restoration accuracy exceeds a predetermined threshold accuracy, and wherein the evaluating of the restoration accuracy is not performed when the distortion type is determined as the first type.

According to an embodiment of the present disclosure, the determining whether the distortion of the field of view of the target camera exists using the first comparison result and the predefined threshold comprises: providing a plurality of sample images received from the target camera to a user, receiving a classification result, in which the user visually classifies each of the plurality of sample images as either a first sample image without a distortion of a field of view or a second sample image with a distortion of a field of view, and determining the predefined threshold by using transformation matrices of the sample images with respect to the reference image and the classification result.

According to an embodiment of the present disclosure, the adjusting the distortion of the field of view of the target camera by using a different field of view adjustment scheme according to the distortion type of the target camera comprises: adjusting the distortion of the field of view of the target camera by controlling a physical movement of the target camera or generating a notification for an operator, when the distortion type is determined as a first type corresponding to a large distortion, and adjusting the distortion of the field of view of the target camera by performing a field of view correction process on the target image, when the distortion type is determined as a second type corresponding to a small distortion, or adjusting the distortion of the field of view of the target camera by controlling the physical movement of the target camera or generating the notification for the operator, when the distortion type is determined as the first type corresponding to a large distortion, and adjusting the distortion of the field of view of the target camera by generating a restored target image corresponding to the target image, when the distortion type is determined as the second type corresponding to a small distortion.

According to an embodiment of the present disclosure, the target object corresponds to a road object, the target object is extracted by using an artificial intelligence model pretrained to output a road region corresponding to the road object within an input image, and in the first extraction result and the second extraction result, remaining regions other than the road object are masked.

According to an embodiment of the present disclosure, wherein the computing device operates in a form integrated into the target camera. The determining of the distortion type of the field of view of the target camera using the first extraction result and the second extraction result comprises: determining the distortion type of the field of view of the target camera, by transmitting the first extraction result and the second extraction result to another computing device external to the computing device and by receiving the distortion type of the field of view of the target camera from the other computing device. The transmitting of the first extraction result and the second extraction result to the other computing device is performed when it is determined, as a result of a comparison between the first extraction result and the second extraction result, that the distortion of the field of view of the target camera exists.

According to an embodiment of the present disclosure, the method further comprises: after the determining of the distortion type of the field of view of the target camera, generating an adjusted region of interest for the target camera, by using the first comparison result, providing the adjusted region of interest to a user, and resetting the target image as the reference image, in response to setting, by the user, the adjusted region of interest or a partially adjusted version of the adjusted region of interest as the region of interest for the target camera.

According to an embodiment of the present disclosure, the distortion type of the target camera includes a first type corresponding to a large distortion and a second type corresponding to a small distortion. The generating of the adjusted region of interest is performed by using an artificial intelligence model to which a pre-set region of interest for the target camera and the first comparison result are input and from which the adjusted region of interest is output. The generating of the adjusted region of interest is performed when the distortion type is the second type, and is not performed when the distortion type is the first type.

According to an embodiment of the present disclosure, the distortion type includes a first type corresponding to a large distortion and a second type corresponding to a small distortion. The adjusting of the distortion of the field of view of the target camera is repeatedly performed for each of periodically received target images in response to the distortion type being determined to be a second type, and is characterized by adjusting the distortion of the field of view of the target camera by replacing each of the target images by using a restored target image generated by applying the first comparison result to each of the target images. The method further comprises: generating an adjusted region of interest for the target camera by using the first comparison result, in response to the distortion type being determined as the second type, and terminating the repeatedly performed adjustment of the distortion of the field of view, in response to a region of interest for the target camera being reset based on the adjusted region of interest.

According to an embodiment of the present disclosure, the generating of the first extraction result and the second extraction result, the determining of whether the distortion of the field of view exists, and the determining of the distortion type are periodically performed according to a first period. The adjusting of the distortion of the field of view is periodically performed according to the first period, when the distortion type is a first type, and wherein the adjusting of the distortion of the field of view is periodically performed according to a second period that is smaller than the first period, when the distortion type is a second type.

According to an embodiment of the present disclosure, a computer program stored in a non-transitory computer readable medium is disclosed. The computer program allows at least one processor of a computing device to perform a method for adjusting a distortion of a field of view of a camera in an intelligent transportation system. The method comprises: receiving a target image captured by a target camera, generating a first extraction result by extracting a predefined target object within the target image from the target image, and generating a second extraction result by extracting the target object within a reference image from the reference image assigned to the target camera, generating a first comparison result between the first extraction result and the second extraction result, determining whether a distortion of the field of view of the target camera exists, using the first comparison result and a predefined threshold, when it is determined that the distortion of the field of view of the target camera exists, determining a distortion type of the field of view of the target camera, using the first comparison result, and adjusting the distortion of the field of view of the target camera by using a different field of view adjustment scheme according to the distortion type of the target camera.

According to an embodiment of the present disclosure, a computing device for adjusting a distortion of a field of view of a camera in an intelligent transportation system is disclosed. The computing device comprises at least one processor and a memory, wherein the at least one processor: receives a target image captured by a target camera, generates a first extraction result by extracting a predefined target object within the target image from the target image, and generates a second extraction result by extracting the target object within a reference image from the reference image assigned to the target camera, generates a first comparison result between the first extraction result and the second extraction result, determines whether a distortion of the field of view of the target camera exists, using the first comparison result and a predefined threshold, when it is determined that the distortion of the field of view of the target camera exists, determines a distortion type of the field of view of the target camera, using the first comparison result, and adjust the distortion of the field of view of the target camera by using a different field of view adjustment scheme according to the distortion type of the target camera.

The technique according to an exemplary embodiment of the present disclosure can efficiently detect an abnormal situation of the field of view and efficiently perform a correction or recovery for the abnormal situation of the field of view.

### BRIEF DESCRIPTION OF THE DRAWINGS

FIG. 1 schematically illustrates a block diagram of a computing device according to an exemplary embodiment of the present disclosure.

FIG. 2 illustratively shows a block diagram of an intelligent transportation system according to an embodiment of the present disclosure.

FIG. 3 illustratively shows a block diagram of an intelligent transportation system for detecting a change in a field of view in an AI camera, according to an embodiment of the present disclosure.

FIG. 4 illustrates an exemplary structure of an artificial intelligence based model according to an exemplary embodiment of the present disclosure.

FIG. 5 shows an exemplary flowchart for adjusting a distortion of a field of view, according to an embodiment of the present disclosure.

FIG. 6 shows an exemplary flowchart for determining a reference image, according to an embodiment of the present disclosure.

FIG. 7 illustratively shows a methodology for determining a reference image, according to an embodiment of the present disclosure.

FIG. 8 shows an exemplary methodology for detecting whether or not a distortion of a field of view has occurred, according to an embodiment of the present disclosure.

FIG. 9 shows an exemplary methodology for determining a type of a distortion of a field of view, according to an embodiment of the present disclosure.

FIG. 10 shows an exemplary methodology for evaluating a recovery accuracy of a target image, according to an embodiment of the present disclosure.

FIG. 11 illustratively shows a methodology for generating an adjusted region of interest and for using the generated region of interest, according to an embodiment of the present disclosure.

FIG. 12 illustratively shows a methodology for comparing extraction results extracted from a target image and a reference image, according to an embodiment of the present disclosure.

FIG. 13 shows an exemplary flowchart for distinguishing a distortion of a field of view and for adjusting the distortion of the field of view, according to an embodiment of the present disclosure.

FIG. 14 shows an exemplary screen comparing a recovered target image and a region of interest, according to an embodiment of the present disclosure.

FIG. 15 schematically shows an exemplary process for detecting and processing an abnormal region of interest, in a case where the abnormal region of interest has occurred due to a distortion of a field of view, according to an embodiment of the present disclosure.

FIG. 16 is a schematic view of a computing environment of a computing device according to an embodiment of the present disclosure.

### DETAILED DESCRIPTION

Various exemplary embodiments will be described with reference to drawings. In the specification, various descriptions are presented to provide appreciation of the present disclosure. Prior to describing detailed contents for carrying out the present disclosure, it should be noted that configurations not directly associated with the technical gist of the present disclosure are omitted without departing from the technical gist of the present disclosure. Further, terms or words used in this specification and claims should be interpreted as meanings and concepts which match the technical spirit of the present disclosure based on a principle in which the inventor can define appropriate concepts of the terms in order to describe his/her invention by a best method.

“Module”, “system”, and the like which are terms used in the specification refer to a computer-related entity, hardware, firmware, software, and a combination of the software and the hardware, or execution of the software, and interchangeably used. For example, the module may be a processing procedure executed on a processor, the processor, an object, an execution thread, a program, application and/or a computing device, but is not limited thereto. One or more modules may reside within the processor and/or a thread of execution. The module may be localized in one computer. One module may be distributed between two or more computers. Further, the modules may be executed by various computer-readable media having various data structures, which are stored therein. The modules may perform communication through local and/or remote processing according to a signal (for example, data from one component that interacts with other components and/or data from other systems transmitted through a network such as the Internet through a signal in a local system and a distribution system) having one or more data packets, for example.

Moreover, the term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” and “at least one” used in this specification designates and includes all available combinations of one or more items among enumerated related items. For example, the term “at least one of A or B” or “at least one of A and B” should be interpreted to mean “a case including only A”, “a case including only B”, and “a case in which A and B are combined”.

Further, it should be appreciated that the term “comprise/include” and/or “comprising/including” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

Terms expressed as N-th such as first, second, or third in the present disclosure are used to distinguish at least one entity. For example, entities expressed as first and second may be the same as or different from each other.

In the present disclosure, the term field of view (FOV) of a camera can indicate the range of a scene that can be captured by the lens of the camera. The size and/or angle of the scene that the camera can see at one time can be defined as the field of view of the camera. For example, the wider the field of view of the camera, the more of a scene can be included in an image captured by the camera, and the narrower the field of view of the camera, the smaller the range of the scene included in the image captured by the camera, but a more detailed scene can be contained in the image.

In the present disclosure, a distortion of a field of view can mean one type of field of view abnormality. For example, the distortion of the field of view can indicate a phenomenon in which, when a camera captures a subject, an object in a specific region of a screen is distorted and becomes different from its original appearance, or the shape, size, or proportion of the object is deformed. For example, the distortion of the field of view can mean a phenomenon in which an area that the camera is targeting deviates from an originally intended area due to a physical cause or the like. For example, because image-based sensors such as cameras are directly affected by exposure to an external environment such as rain, snowfall, and/or wind, they may be vulnerable to a distortion of a field of view if there is no continuous maintenance. Furthermore, in a situation where a camera is used concurrently with other equipment, an external impact that can affect the field of view of the corresponding camera can occur during a maintenance process of the other equipment, and a distortion of the field of view can occur accordingly. A distortion of a field of view can mean a misalignment of field of view. A distortion of a field of view can mean a deviation of field of view. Hereinafter, embodiments of the present disclosure will be described using the term “distortion of a field of view” as an example of an abnormal situation of field of view.

FIG. 1 schematically illustrates a block diagram of a computing device 100 according to an exemplary embodiment of the present disclosure.

The computing device 100 according to an exemplary embodiment of the present disclosure may include a processor 110 and a memory 130.

A configuration of the computing device 100 illustrated in FIG. 1 is only an example simplified and illustrated. In an exemplary embodiment of the present disclosure, the computing device 100 may include other components for performing a computing environment of the computing device 100, and only some of the disclosed components may constitute the computing device 100.

The computing device 100 in the present disclosure may be interchangeably used with the computing device, and the computing device 100 may be used as a meaning that encompasses an any type of server and an any type of terminal.

The computing device 100 in the present disclosure may mean an any type of component constituting a system for implementing the exemplary embodiments of the present disclosure.

The computing device 100 may mean an any type of user terminal or an any type of server. The components of the computing device 100 are exemplary, and some components may be excluded or an additional component may also be included. As an example, when the computing device 100 includes the user terminal, an output unit (not illustrated) and an input unit (not illustrated) may be included in a range of the computing device 100. For example, the computing device 100 may mean a server of a CCTV control center. For example, the computing device 100 may correspond to one of the entities included in the CCTV control center. For example, the computing device 100 may correspond to an edge device capable of communicating with a CCTV control center and a camera. For example, the computing device 100 may be included in a camera (e.g., an AI camera) to perform at least a part of a method according to an embodiment of the present disclosure.

In an embodiment, the computing device 100 may detect a distortion of a field of view of a target camera that acquired a target image by using a first extraction result extracted from the target image and a second extraction result extracted from a reference image, recover the target image, determine a type of the distortion of the field of view of the target camera, adjust the distortion of the field of view according to the type of the distortion of the field of view, and/or reset the reference image and/or a region of interest of the target camera using information about the distortion of the field of view.

In an exemplary embodiment, the processor 110 may be constituted by at least one core, and include processors for data analysis and processing, such as a central processing unit (CPU), a general purpose graphics processing unit (GPGPU), a tensor processing unit (TPU), etc., of the computing device 100.

The processor 110 can read a computer program stored in a memory 130 and perform the method according to an embodiment of the present disclosure. In one embodiment, the memory 130 may include a storage unit for storing information.

According to an exemplary embodiment of the present disclosure, the processor 110 may perform an operation for learning the neural network. The processor 110 may perform calculations for learning the neural network, which include processing of input data for learning in deep learning (DL), extracting a feature in the input data, calculating an error, updating a weight of the neural network using backpropagation, and the like. At least one of the CPU, the GPGPU, and the TPU of the processor 110 may process learning of the network function. For example, the CPU and the GPGPU may process the learning of the network function and data classification using the network function. Further, in an exemplary embodiment of the present disclosure, learning of the network function and data classification using the network function may also be processed by using processors of a plurality of computing devices. In addition, the computer program performed by the computing device 100 according to an exemplary embodiment of the present disclosure may be a CPU, GPGPU, or TPU executable program.

Additionally, the processor 110 may generally process all operations of the computer device 100. For example, the processor 110 processes data, information, or a signal input or output through the components included in the computing device 100 or drives an application program stored in a storage unit to provide an appropriate information or function to a user.

According to an exemplary embodiment of the present disclosure, the memory 130 may store various types of information generated or determined by the processor 110 or various types of information received by the computing device 100. According to an exemplary embodiment of the present disclosure, the memory 130 may be a storage medium storing computer software which performs the operations according to the exemplary embodiments of the present disclosure by the processor 110. Therefore, the memory 130 may also mean computer reading media for storing a software code required for performing the exemplary embodiment of the present disclosure, data which becomes an execution target of the code, and an execution result of the code.

The memory 130 according to an exemplary embodiment of the present disclosure may mean an arbitrary type of storage medium. For example, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may also operate in connection with a web storage performing a storing function of the memory 130 on the Internet. The disclosure of the memory is just an example, and the memory 130 used in the present disclosure is not limited to the examples.

A communication unit (not illustrated) in the present disclosure may be configured regardless of communication modes such as wired and wireless modes and constituted by various communication networks including a personal area network (PAN), a wide area network (WAN), and the like. Further, the network unit 150 may be the known World Wide Web (WWW) and may adopt a wireless transmission technology used for short-distance communication, such as infrared data association (IrDA) or Bluetooth.

The computing device 100 in the present disclosure may include various types of user terminal and/or various types of server. Therefore, the exemplary embodiments of the present disclosure may be performed by the server and/or the user terminal.

In an exemplary embodiment, the user terminal may include an arbitrary type of terminal which is capable of interacting with the server or another computing device. The user terminal may include, for example, a cellular phone, a smart phone, a laptop computer, a personal digital assistant (PDA), a slate PC, a tablet PC, and an ultrabook.

In an exemplary embodiment, the server may include, for example, various types of computing system or computing device such as a microprocessor, a mainframe computer, a digital processor, a portable device, and a device controller.

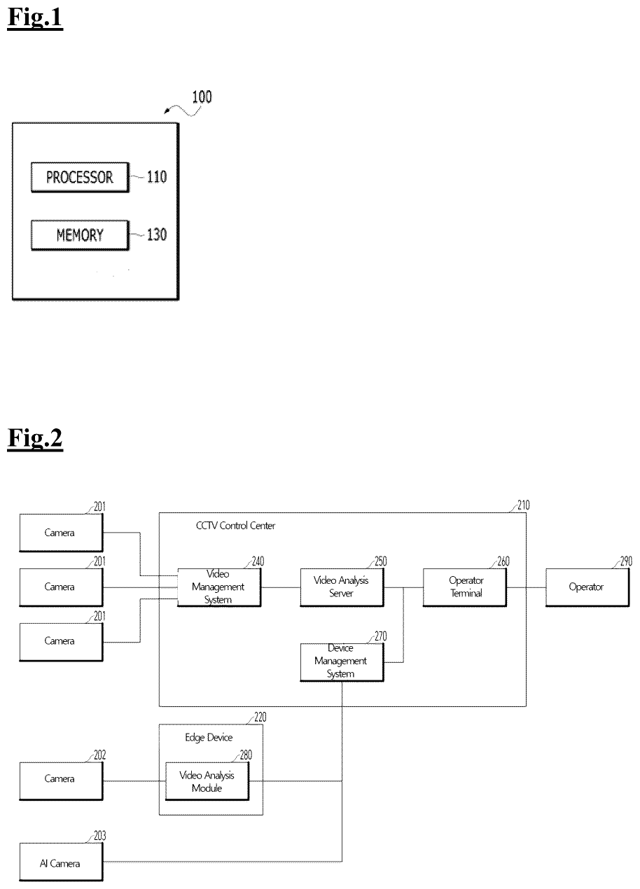

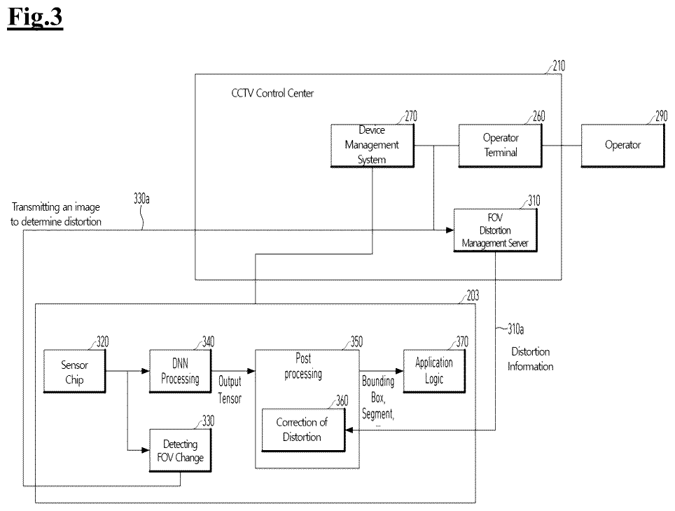

FIG. 2 illustratively shows a block diagram of an intelligent transportation system according to an embodiment of the present disclosure.

As illustrated in FIG. 2, an intelligent transportation system according to an embodiment of the present disclosure may include a plurality of cameras 201 that capture a target area, a CCTV (Closed-Circuit Television) control center 210, and an operator 290. In an embodiment of the present disclosure, a user and an operator 290 can be interchangeably used.

In the present disclosure, the CCTV control center 210 may be used interchangeably with an intelligent control center, an intelligent transportation control center, and/or a transportation control center.

The camera 201 may, for example, capture a target area in the intelligent transportation system and generate a capture result in a region of interest within the captured image. The camera 201 is a device that captures an image for monitoring road and/or traffic conditions in the intelligent transportation system and may include an RGB camera, a depth-sensing camera, a high-resolution video camera, an infrared camera, and/or a thermal imaging camera.

The CCTV control center 210 may represent an entity that performs various functions in the intelligent transportation system. The CCTV control center 210 is capable of communicating with the camera 201 and the operator 290, and may process an image received from the camera 201 to provide the operator 290 with information about abnormal situation, road conditions, and/or traffic conditions. The CCTV control center 210 may generate results from an image, such as vehicle license plate recognition, traffic violation detection, traffic volume detection, road condition detection, traffic accident or emergency situation detection, and/or traffic signal control. As an example, the CCTV control center 210 may correspond to the computing device 100 of FIG. 1.

The CCTV control center 210 may include a video management system 240, a video analysis server 250, a device management server 270, and/or an operator terminal 260.

The CCTV control center 210 may manage the distortion of a plurality of cameras 201, 202, and/or 203 (e.g., video channels). At the time when the video analysis server 250 is configured by the operator terminal 260 (configuration for ROI and/or a perspective transformation matrix, etc.), setting information for a reference image (e.g., channel information corresponding to a camera) may be delivered to the CCTV control center 210. The CCTV control center 210 may store the reference image in a database and start monitoring the field of view of the camera using the corresponding video channel. The CCTV control center 210 may detect whether a distortion of the camera exists by using the reference image and a target image. In a case where the CCTV control center 210 determines that a distortion exists, it may perform a restoration or a recovery (e.g., angle correction) for the target image and generate distortion analysis information. The CCTV control center 210 may store the distortion analysis information corresponding to the camera and an image to be corrected (e.g., the target image and/or a restored target image) in the database. According to the corresponding information, the CCTV control center 210 (e.g., the video analysis server 250) may perform a fine correction related to the camera by using the information stored in the database, and the operator terminal 260 may perform a distortion management operation corresponding to the camera by using the information stored in the database. For example, the distortion management operation may include an operation of resetting a region of interest corresponding to the camera, an operation of resetting a reference image corresponding to the camera, and/or an operation of determining a distortion-related adjustment scheme for the camera. In an embodiment, if a distortion is detected at the time when a correction for an image is in progress, it may be determined whether an additional distortion related to the camera has occurred by using not only the reference image but also the image to be corrected.

The video management system 240 may store and manage images received from the camera 201. For example, the video management system 240 may store and manage images by time period, by area, and/or by camera (e.g., in the unit of time period, in the unit of area and/or in the unit of camera). The video management system 240 may preprocess images received from the camera 201 (e.g., noise removal, unnecessary image removal, image quality improvement, and/or image tag generation, etc.). The video management system 240 may deliver an image required for processing and analysis in the video analysis server 250 to the video analysis server 250. The video management system 240 may comprehensively manage the cameras 201 and the images received from the cameras 201, and/or generate analysis results for the images. The video management system 240, in conjunction with (or interactively) the video analysis server 250, may provide traffic information and event information for an area to be monitored to the operator terminal 260. The event information may include information related to a vehicle's movement, speed, a signal state of an intersection, and/or a state of a distortion of a field of view of a camera, and through this, an alarm for an abnormal situation may be implemented.

The video analysis server 250 may determine whether a distortion of the field of view of the camera 201 exists by using an image. The video analysis server 250 may determine the distortion type of the field of view of the camera 201 by using an image. The video analysis server 250 may recover or restore an image. The video analysis server 250 may reset a region of interest and/or a reference image of the camera 201 by using field of view distortion information. The video analysis server 250 may perform the methods according to an embodiment of the present disclosure by using an artificial intelligence model. For example, the video analysis server 250 may extract a target object from an image by using a segmentation model trained to extract a predefined object within an input image. For example, the video analysis server 250 may extract feature points of an object within an image by using a feature point extraction model trained to extract feature points of an object within an input image.

In an embodiment, the CCTV control center 210 may include a field of view distortion management server (not shown). In another embodiment, the video analysis server 250 may be configured to include a field of view distortion management server (not shown). The field of view distortion management server (not shown) may receive a target image and a reference image, detect a distortion using the received target image and reference image, perform a restoration or a recovery for the target image, evaluate a restoration result or a recovery result for the target image, and deliver the target image to be corrected to the video analysis server 250. The video analysis server 250 may perform a correction for the target image to be corrected.

The device management server 270 is capable of communicating with an edge device 220 external to the CCTV control center 210 and may manage and control the operation of the edge device 220. For example, the edge device 220 may analyze an image received from the camera 202 through a video (or an image) analysis module 280, and the analysis result of such an edge device 220 may be delivered to the CCTV control center 210 through the device management server 270. The device management server 270 may determine whether an operation of the edge device 220 is executed and/or whether an abnormality of the operation of the edge device 220 exists. The device management server 270 may control the operation of the camera 202 connected to the edge device 220 and/or determine whether an abnormality of the camera 202 exists. The device management server 270 may control the operation of an AI (Artificial Intelligence) camera 203 and determine whether an abnormality of the AI camera 203 exists.

The operator terminal 260, as a terminal that allows a user's control within the CCTV control center 210, may perform or allow user control over the overall operation of the CCTV control center 210 and/or user control over the entities 250, 260, and 270 included within the CCTV control center 210. The operator terminal 260 is operable according to the control of an operator 290, may receive processed information from the video analysis server 250 and/or the device management server 270, and may control the operation of the video analysis server 250 and/or the device management server 270 according to the control of the operator 290. The operator terminal 260 may include an input unit and an output unit for interacting with the operator 290. The input unit of the operator terminal 260 receives a user input from the operator 290, and the output unit of the operator terminal 260 may provide the operator 290 with information related to the intelligent transportation system.

The computing device 100 according to an embodiment of the present disclosure may correspond to the video (or an image) management system 240, the video (or an image) analysis server 250, the device management server 270, and/or the operator terminal 260.

An embodiment of the present disclosure illustratively shows an intelligent transportation system using an edge device 220 that receives a video from a camera 202. The edge device 220 may directly perform at least a part of the operations of the CCTV control center 210. The edge device 220 may, for example, be installed at a site such as a roadside and perform an operation of processing and/or analyzing a video received from the camera 202. The edge device 220 may mean a separate device having the computational ability to process at least a part of the functions of the CCTV control center 210. The video analysis operation of the edge device 220 may be performed by a video analysis module 280 of the edge device 220. In an embodiment, the video analysis module 280 may perform at least a part of the operations performable by the video analysis server 250. The video analysis module 280 may process a video received from the camera 202 at a location closer to the site than the video analysis server 250. The edge device 220 may deliver the video analyzed and/or processed by the video analysis module 280 to the device management server 270 to allow images for the various cameras 201, 202, and 203 to be integrated, managed, and processed within the CCTV control center 210.

In an embodiment, the edge device 220 may communicate with the CCTV control center 210 to jointly perform distortion detection, distortion correction, and traffic-related application operations for an image received through the camera 202. The edge device 220 may decode an image received from the camera 202, and detect whether a distortion exists by comparing the decoded image with a reference image. The edge device 220 may perform a restoration or a recovery (e.g., angle correction) for an image in which a distortion is detected and may perform an evaluation for the restored image. The edge device 220 may transmit an evaluation result for the recovered image to the device management server 270 to allow the CCTV control center 210 to obtain a distortion notification for the corresponding camera. The edge device 220 may use the reference image and the restored image during the evaluation. The edge device 220 may generate distortion information (e.g., transformation information, etc.) by using a comparison result between the reference image and the decoded image, or a restoration result of the restored image, or an evaluation result of the restored image, and may perform a correction for the image by using the distortion information. The edge device 220 may perform DNN (Deep Neural Network) processing for an image to which a distortion correction has been applied to generate an output tensor, and perform post-processing on the output tensor to generate a segmentation result and/or an object detection result for a predefined object within the image. The edge device 220 is capable of communicating with the device management server 270 and may receive setting information (or setting update information) (e.g., a region of interest) for a camera from the device management server 270. The edge device 220 may perform various traffic-related application operations within the CCTV control center 210 by using the setting information or the setting update information. In a case where the edge device 220 operates independently of the CCTV control server 210, as described above, a function related to distortion detection and distortion correction may be performed together with an artificial intelligence-based video inference pipeline within the edge device 220. Regarding the distortion correction, the edge device 220 may perform the distortion correction using the distortion information at the time when a resize process of an image is performed in a pre-processing step before a DNN processing operation within the edge device 220.

In an embodiment, the edge device 220 may be capable of linking or cooperating with the CCTV control server 210. The edge device 220 may also be capable of operating independently of the CCTV control server 210 due to security issues, privacy issues, and/or communication network issues. The edge device 220 in the present disclosure may correspond to the computing device 100.

An embodiment of the present disclosure illustratively shows an intelligent transportation system using an AI camera 203. The AI camera 203 may directly perform at least a part of the operations of the CCTV control center 210. The AI camera 203 may represent a device in which artificial intelligence technology is integrated into the cameras 201 and 202. The AI camera 203 may represent a device in which a video processing function is integrated into the cameras 201 and 202. The AI camera 203 may represent a device in which an artificial intelligence-related processing function is added to the functions of the cameras 201 and 202. The AI camera 203 may capture an image and directly perform video processing and video analysis on the captured image. The AI camera 203 may deliver the analyzed and/or processed video to the device management server 270 to allow images for the various cameras 201, 202, and 203 to be integrated, managed, and processed within the CCTV control center 210. The AI camera 203 in the present disclosure may correspond to the computing device 100.

In an embodiment, the CCTV control center 210 may record a history for an area where a distortion of a field of view frequently occurs, through distortion detection, distortion type, distortion analysis, and/or distortion adjustment obtained through a technique according to an embodiment of the present disclosure. The CCTV control center 210 may analyze and store the cause of a distortion of a field of view and/or the form of the distortion through a technique according to an embodiment of the present disclosure. For example, a technical effect can be achieved in that the computing device 100 can implement efficient maintenance of the CCTV control system 210 in the future by distinguishing between a temporary and random type of field of view distortion due to a typhoon, rain, and/or wind, and a type of field of view distortion having a continuous tendency due to a sagging phenomenon through loose fastening of a camera support or a sagging phenomenon due to loose fastening of a structure. In an embodiment, the cause of the distortion of the field of view and/or the form of the distortion may be determined by using information obtained in the adjustment or correction step of the field of view distortion.

FIG. 3 illustratively shows a block diagram of an intelligent transportation system for detecting a change in a field of view in an AI camera, according to an embodiment of the present disclosure.

In an embodiment, because the AI camera 203 may have less computational capability or computational power compared to the edge device 220, it may be difficult to determine a field of view distortion of an image using the own computational capability of the AI camera 203. Therefore, the AI camera 203 according to an embodiment of the present disclosure may transmit an image for determining a distortion to the CCTV control center 210 (e.g., a field of view distortion management server 310) (330a). The AI camera 203 may receive field of view distortion information (e.g., information about whether a distortion exists, information about a distortion type, image restoration information, and/or transformation information) using the image from the CCTV control center 210 (e.g., the field of view distortion management server 310) (310a). In an embodiment, the field of view distortion management server 310 may generate whether a distortion of a field of view exists, a distortion type of a field of view, and/or field of view distortion information (e.g., transformation information) from the received image. In an embodiment, the field of view distortion management server 310 may perform a restoration for the received image.

In an embodiment, the AI camera 203 may perform or run an intelligent transportation system-related application for the corresponding image by using the field of view distortion information received through application logic 370. For example, the intelligent transportation system-related application may include vehicle type detection, traffic volume measurement, traffic light control, ramp control, dangerous situation detection, vehicle movement detection, and/or vehicle license plate detection, within an image.

In an embodiment, the AI camera 203 may acquire an image and/or perform preprocessing for the image through a sensor chip 320. The AI camera 203 may determine whether a change in the field of view exists for the image (303). In a case where a change in the field of view for the camera 203 is detected using the acquired image, the AI camera 203 may transmit the image for determining a distortion to the field of view distortion management server 310. The AI camera 203 may perform DNN processing for the image by using an artificial intelligence model. For example, the DNN processing may include extracting a feature for an input image and/or generating an output tensor for the input image. The AI camera 203 may generate a segmentation result, a pixel detection result, and/or an object detection result for the image in a post-processing process 350. The generated results (e.g., a bounding box, a segmentation result, etc.) may be utilized in the application logic 370 to perform a traffic-related application function. The AI camera 203 may perform a distortion correction 360 for the image in the post-processing process 350 after the DNN processing operation, by using the distortion information received from the field of view distortion management server 310. In such a case, the AI camera 203 may correct the segmentation result, the pixel detection result, and/or the object detection result for the image in the post-processing process 350 by using the distortion information.

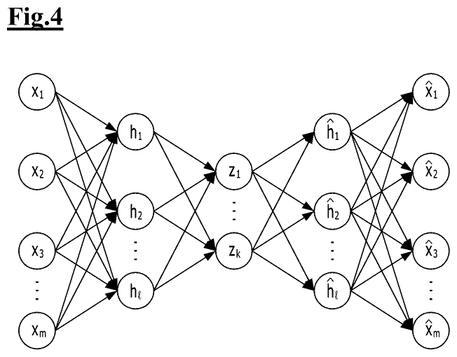

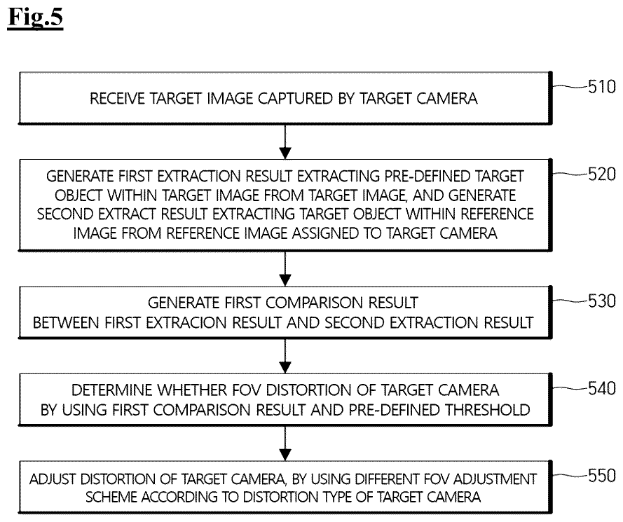

FIG. 4 illustrates an exemplary structure of an artificial intelligence-based model according to an exemplary embodiment of the present disclosure.

Throughout the present disclosure, the model, the artificial intelligence model, the artificial intelligence-based model, the operation model, and the neural network, the network function, and the neural network may be used interchangeably.

The artificial intelligence-based model in the present disclosure may include models which are utilizable in various domains, such as a model for image processing such as object segmentation, object detection, and/or object classification, a model for text processing such as data prediction, text semantic inference and/or data classification, etc.

The neural network may be generally constituted by an aggregate of calculation units which are mutually connected to each other, which may be called “node”. The nodes may also be called neurons. The neural network is configured to include one or more nodes. The nodes (or neurons) constituting the neural networks may be mutually connected to each other by one or more links.

The node in the artificial intelligence-based model may be used to mean a component that constitutes the neural network, and for example, the node in the neural network may correspond to the neuron.

In the neural network, one or more nodes connected through the link may relatively form a relationship between an input node and an output node. Concepts of the input node and the output node are relative and a predetermined node which has the relationship of the output node with respect to one node may have the relationship of the input node in the relationship with another node and vice versa. As described above, the relationship of the output node to the input node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable, and the weight may be varied by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form the input node and output node relationship in the neural network. A characteristic of the neural network may be determined according to the number of nodes, the number of links, correlations between the nodes and the links, and values of the weights granted to the respective links. For example, when the same number of nodes and links exist and two neural networks in which the weight values of the links are different from each other exist, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed from the initial input node up to the corresponding node. However, definition of the layer is predetermined for description and the order of the layer in the neural network may be defined by a method different from the aforementioned method. For example, the layers of the nodes may be defined by the distance from a final output node.

In an exemplary embodiment of the present disclosure, the set of the neurons or the nodes may be defined as the expression “layer”.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean not the initial input node and the final output node but the nodes constituting the neural network.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

The deep neural network (DNN) may mean a neural network including a plurality of hidden layers other than the input layer and the output layer. When the deep neural network is used, the latent structures of data may be identified. That is, photographs, text, video, voice, protein sequence structure, genetic sequence structure, peptide sequence structure, potential structure of music (e.g., what objects are in the photo, what is the content and emotions of the text, what contents and emotions of the voice, etc.) may be identified. The deep neural network may include convolutional neural network (CNN), recurrent neural network (RNN), auto encoder, generative adversarial networks (GAN), restricted Boltzmann machine (RBM), deep belief network (DBN), Q network, U network, Siamese network, etc. The description of the deep neural network described above is just an example and the present disclosure is not limited thereto.

The artificial intelligence-based model of the present disclosure may be expressed by a network structure of an arbitrary structure described above, including the input layer, the hidden layer, and the output layer.

The neural network which may be used in a clustering model in the present disclosure may be learned in at least one scheme of supervised learning, unsupervised learning, semi supervised learning, or reinforcement learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data. As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

According to an exemplary embodiment of the present disclosure, a computer readable medium is disclosed, which stores a data structure including the benchmark result and/or the artificial intelligence based model. The data structure may be stored in a storage unit (not illustrated) in the present disclosure, and executed by the processor 110 and transmitted and received by a communication unit (not illustrated).

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection relationship between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an effectively designed data structure, a computing device may perform operations while using the resources of the computing device to a minimum. Specifically, the computing device may increase the efficiency of operation, read, insert, delete, compare, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for learning the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for learning the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called “node”. The nodes may also be called neurons. The neural network is configured to include one or more nodes.

The data structure may include data input into the neural network. The data structure including the data input into the neural network may be stored in the computer readable medium. The data input to the neural network may include learning data input in a neural network learning process and/or input data input to a neural network in which learning is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight may be varied by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network learning process and/or a weight in which neural network learning is completed. The weight which varies in the neural network learning process may include a weight at a time when a learning cycle starts and/or a weight that varies during the learning cycle. The weight in which the neural network learning is completed may include a weight in which the learning cycle is completed. Accordingly, the data structure including the weight of the neural network may include a data structure including the weight which varies in the neural network learning process and/or the weight in which neural network learning is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, R-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of learning cycle iterations, weight initialization (for example, setting a range of weight values to be subjected to weight initialization), and Hidden Unit number (e.g., the number of hidden layers and the number of nodes in the hidden layer). The data structure is just an example, and the present disclosure is not limited thereto.

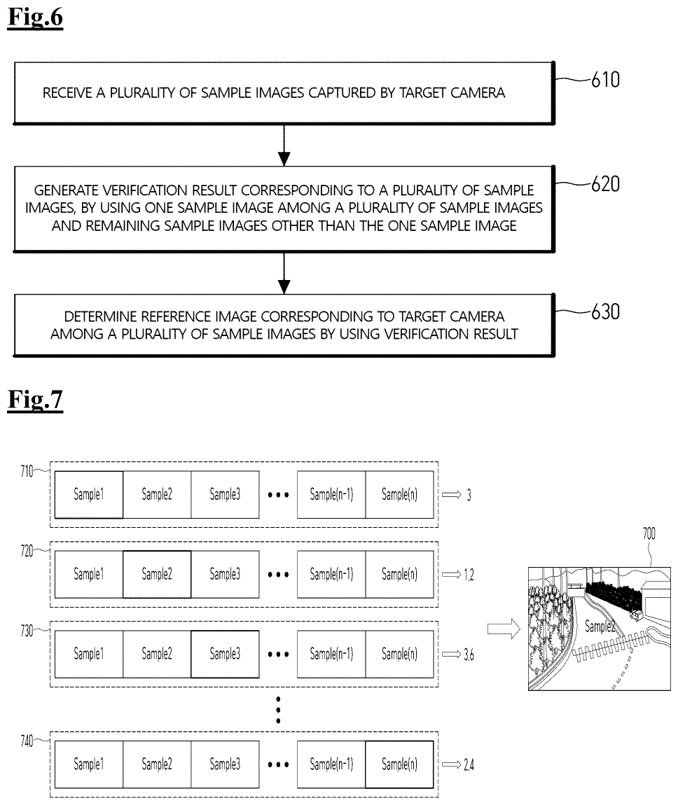

FIG. 5 shows an exemplary flowchart for adjusting a distortion of a field of view, according to an embodiment of the present disclosure.

At least a part of the steps illustrated in FIG. 5 may be performed by a computing device 100.

In an embodiment, the computing device 100 may receive a target image captured by a target camera (510).

In an embodiment, the target camera may represent a camera that is the subject of the determination and adjustment of a field of view distortion. For example, the target camera may be a fixed camera that captures a predefined area. For example, the target camera may be a camera for acquiring traffic-related data. For example, the target camera may include a CCTV (Close-Circuit Tele Vision) camera used to monitor traffic volume and/or traffic flow, an ANPR (Automatic Number Plate Recognition)/LPR (License Plate Recognition) camera used to recognize vehicle license plates, an infrared camera, a speed detection camera, a thermal imaging camera, a panoramic camera, an RGB camera, a depth-sensing camera, and/or a stereo camera.

In an embodiment, the target image may represent an image captured by the target camera. In an embodiment, the target image may mean an image captured from a video recorded by the target camera. For example, the target image may include an RGB (red-green-blue) image and/or a grayscale image.

In an embodiment, the computing device 100 may generate a first extraction result by extracting a predefined target object from within the target image, and generate a second extraction result by extracting the target object from within a reference image assigned to the target camera (520).

In an embodiment, the computing device 100 may generate an extraction result that outputs a predefined target object from within an input image by using an artificial intelligence model. For example, the computing device 100 may generate a detection result for a predefined target object within an input image by using a pre-trained object detection model. The detection result herein may include a bounding box corresponding to the object. For example, the computing device 100 may generate a segmentation result corresponding to a predefined target object within an input image by using a pre-trained segmentation model. The segmentation model is an artificial intelligence model that operates to predict which class each pixel belongs to within an input image, and may generate a segmentation result that distinguishes classes such as vehicle, road, person, and/or building within the image. The segmentation in the present disclosure may include semantic segmentation, which generates the same result for a plurality of objects belonging to the same class, and instance segmentation, which generates different results for a plurality of objects belonging to the same class. The extraction result in the present disclosure may include a segmentation result. A technique related to field of view distortion according to an embodiment of the present disclosure may, for example, divide an image into several pixel sets using semantic segmentation technology and represent the classification result for all pixels in the image. As semantic segmentation technology is applied to the technique related to field of view distortion, it becomes possible to detect fine pixel changes, and a more accurate and precise determination of the field of view distortion may become possible.

In an embodiment, the target object may be extracted by using a pre-trained artificial intelligence model that outputs a road region corresponding to a road object within an input image. In an embodiment, in the first extraction result and the second extraction result, the remaining regions excluding the target object (e.g., a road object) may be masked. As such, the computing device 100 may generate an extraction result corresponding to each of the reference image and the target image in a manner of detecting the same target object for the reference image and the target image.

In an embodiment, the first extraction result may represent a segmentation result obtained when the target image is input to an artificial intelligence model, and the second extraction result may represent a segmentation result obtained when the reference image is input to an artificial intelligence model. By way of example and not limitation, the target object in the present disclosure may include a road. For example, the first extraction result and the second extraction result may mean the result of extracting a target object corresponding to a predefined road within an image. In the road region, there are several distinct features drawn with separate lines, such as for example, white lines or yellow lines, and there may be an invariance of these distinct features. Furthermore, the road region may have robust characteristics against external environments such as day, night, and weather. Furthermore, the road region may correspond to an area that is easy to accurately identify with streetlights or various lights. Accordingly, a technique according to an embodiment of the present disclosure, by determining the target object as a road object, can compare the reference image and the target image in a more efficient manner, and accordingly, a resource-efficient and highly accurate field of view distortion determination and restoration may be implemented.

The reference image in the present disclosure may be an image used to determine the distortion of the field of view of the target camera by being compared with the target image. For example, the reference image may be an image pre-assigned to the camera. A detailed description of the reference image will be given later in FIG. 6.

In an additional embodiment, the first extraction result and the second extraction result may also include results in which feature points for the target object are extracted. In this embodiment, the first extraction result may include feature points included in the segmented target object within the target image, and the second extraction result may include feature points included in the segmented target object within the reference image. The feature points may be extracted by a pre-trained feature point extraction model. The feature point extraction model may be configured to take the segmented target object as input and output feature points that constitute the target object. The feature point extraction model will be described in detail below.

In an embodiment, the computing device 100 may generate a first comparison result between the first extraction result and the second extraction result (530).

In an embodiment, the computing device 100 may compare the feature points of the first extraction result and the feature points of the second extraction result. For example, the comparison of feature points may include matching or comparison between the pixel coordinates of the feature points. For example, the comparison of feature points may also be performed by comparing the descriptors of the feature points. As described above, the computing device 100 may implement a more resource-efficient and accurate feature point comparison by matching the feature points corresponding to the target object within the target image with the feature points corresponding to the target object within the reference image.

In an embodiment, the computing device 100 may extract the feature points of the target object from the first extraction result, and extract the feature points of the reference object from the second extraction result. The computing device 100 may obtain the pixel coordinates corresponding to the feature points of the target object from the first extraction result. The computing device 100 may obtain the pixel coordinates and a descriptor corresponding to the feature points of the target object from the first extraction result. The computing device 100 may obtain the pixel coordinates corresponding to the feature points of the target object from the second extraction result. The computing device 100 may obtain the pixel coordinates and a descriptor corresponding to the feature points of the target object from the second extraction result.

In an embodiment, the computing device 100 may obtain feature points from the first extraction result and the second extraction result, respectively, by using a pre-trained feature point extraction model. The feature point extraction model may correspond to a pre-trained artificial intelligence model based on supervised learning to recognize, as a feature point, a point where the amount of change for at least one of color or a geometric pattern in an object within an image exceeds a predetermined threshold. As an example, the feature point extraction model may correspond to a pre-trained artificial intelligence model using an image-based neural network. As another example, the feature point extraction model may correspond to a pre-trained artificial intelligence model using a Transformer-based neural network.

In an embodiment, the computing device 100 may generate transformation information that represents a distortion between the target image and the reference image by matching the feature points included in the first extraction result of the target image and the feature points included in the second extraction result of the reference image. For example, the computing device 100 may match the feature points included in the first extraction result with the feature points included in the second extraction result and generate a transformation matrix that represents a distortion between the target image and the reference image by using the matched feature points (e.g., by using the pixel coordinates of the matched feature points). In an embodiment, the first comparison result may include transformation information that represents a distortion between the target image and the reference image. For example, the transformation information may include a transformation matrix. For example, the transformation information may include an Affine transformation matrix. An Affine transformation may mean a geometric transformation that preserves the parallelism of lines. An Affine transformation means a geometric transformation made of various combinations such as translation, scaling, and rotation of an image, and can transform the image while maintaining or preserving linearity. For example, the transformation information may represent the difference between the reference image and the target image based on the target object (e.g., a road object). For example, the transformation information may include a transformation matrix used to restore the target image to the reference image. For example, the transformation information may be represented by a rotation matrix and/or a translation vector.

In an embodiment, the computing device 100 may determine whether a distortion of the field of view of the target camera exists, by using the first comparison result and a predefined threshold (540).

In an embodiment, in a case where the transformation information (e.g., a transformation matrix, etc.) included in the first comparison result is greater than a predefined threshold, the computing device 100 may determine that a distortion of the field of view of the target camera exists. For example, the computing device 100 may automatically determine whether a distortion of the field of view of the target camera exists.

In an embodiment, the computing device 100 may determine the threshold by using a classification result obtained from a plurality of sample images received from the target camera. For example, the computing device 100 may provide a plurality of sample images received from the target camera to a user. The computing device 100 may receive from the user a classification result in which each of the plurality of sample images is classified as one of a first sample image without a field of view distortion and a second sample image with a field of view distortion. The computing device 100 may determine the predefined threshold by using transformation matrices of the sample images with respect to the target image and the classification result. The computing device 100 may determine the predefined threshold by using transformation matrices of the sample images with respect to the reference image and the classification result.

In an embodiment, an image with a distortion and an image without a distortion may be distinguished (e.g., visually) by a user through previously secured (or obtained) field of view change image data (e.g., sample images). The computing device 100 may extract transformation information between the sample images and the reference image by using classified result data. For example, the computing device 100 may obtain a segmentation result for each of the sample images (e.g., a segmentation result for a target object) by inputting each of the sample images into a segmentation model, and may generate transformation information for each of the sample images as a result of comparing (or matching) feature points in the segmentation result for the reference image (e.g., a segmentation result for a target object) and the segmentation result for each of the sample images. This transformation information may represent the distortion between the sample image and the reference image. The computing device 100 may set, as a criterion for determining the presence of a distortion, a point that best distinguishes the value of the distortion transformation matrix possessed by an image with a distortion and an image without a distortion. The computing device 100 may determine, as a criterion, a value that best distinguishes the true/false classified by a person based on a shift value (or a rotation value is also possible) among the values included in the transformation matrix. The computing device 100 may determine whether the distortion of the target image is greater than the criterion. If it is greater than the criterion, the computing device 100 may determine that the target image has a distortion, and if it is smaller than the criterion, it may determine that the target image does not have a distortion.

In an embodiment, in a case where it is detected that the target image has a distortion compared to the reference image, the computing device 100 may perform a restoration (e.g., Angle correction) for the target image. In an embodiment, in a case where it is detected that the target image has a distortion compared to the reference image, the computing device 100 may perform an operation for determining a distortion type. In an embodiment, in a case where it is detected that the target image has a distortion compared to the reference image, the computing device 100 may determine to perform an operation for adjusting the distortion of the target camera.

In an additional embodiment, the computing device 100 may omit the step of determining whether a distortion of the field of view of the target camera exists. For example, in a case where the first comparison result between the first extraction result and the second extraction result has been generated, the computing device 100 may determine the distortion type of the field of view of the target camera by using the first comparison result, regardless of whether a distortion of the field of view exists.

In an embodiment, the computing device 100 may adjust the distortion of the field of view of the target camera by using a different field of view adjustment scheme according to the distortion type of the target camera (550).

In the present disclosure, the distortion type of the field of view of the target camera may include a plurality of types. By way of example and not limitation, the distortion type of the field of view of the target camera may include a first type representing a large distortion and a second type representing a small distortion. In this example, the distortion type of the FOV of the target camera can include 2 types. For example, the distortion type of the field of view of the target camera may be linked to the method of distortion adjustment for the target camera. For example, the method of distortion adjustment for the target camera may be determined according to the distortion type of the field of view of the target camera. For example, if the distortion types of the field of view of the target camera are different, the methods of distortion adjustment for the target camera may also be different.

In an embodiment, the computing device 100 may determine the distortion type of the field of view of the target camera by using a comparison result from comparing the first extraction result and the second extraction result.

In an embodiment, the computing device 100 may determine the distortion type of the field of view of the target camera by using a transformation matrix included in the comparison result.

In an embodiment, the computing device 100 may determine the distortion type of the field of view of the target camera by using a result of restoring the target image to match the reference image. The restoration of the target image may mean changing the target image to match the reference image by using a comparison result (e.g., transformation information, a transformation matrix, an Affine transformation matrix, etc.) determined using the target image and the reference image. For example, the computing device 100 may generate a restored target image by applying a transformation matrix included in the transformation information to the target image so that the target image matches the reference image. The computing device 100 may determine the distortion type of the field of view of the target camera by using the restored target image.

In an embodiment, the computing device 100 may determine whether the distortion type of the field of view of the target camera is a first type corresponding to a large distortion or a second type corresponding to a small distortion, by using the size of a noise region generated in the process of restoring the target image within the restored target image. The noise region may represent a black (or white) margin region in the restored target image that results from applying the transformation matrix to the target image. In the process of restoring, a part of the target image may be expressed in the form of a margin region, and the distortion type of the field of view of the target camera may be determined by using the size of this margin region. For example, in a case where the size of the noise region is larger than a predefined threshold size, the distortion type may be determined as a first type corresponding to a large distortion. For example, in a case where the size of the noise region is less than or equal to a predefined threshold size, the distortion type may be determined as a second type corresponding to a small distortion.

In an embodiment, the computing device 100 may determine the distortion type of the field of view of the target camera by comparing the noise region of the restored target image and a region of interest (ROI) set for the target camera. The computing device 100 may determine whether an overlapping region exists between the noise region of the restored target image and the region of interest (ROI) set for the target camera, and may link the existence of the overlapping region to the distortion type of the field of view. Whether the presence of the overlapping region can be correlated to the distortion type of the field of view. For example, in a case where the noise region of the restored target image at least partially overlaps with the region of interest, the computing device 100 may determine the distortion type of the field of view of the target camera as a first type corresponding to a large distortion. For example, in a case where the noise region of the restored target image does not overlap with the region of interest, the computing device 100 may determine the distortion type of the field of view of the target camera as a second type corresponding to a small distortion.

In an embodiment, the computing device 100 may evaluate the restoration accuracy of the restored target image. Evaluating the restoration accuracy may represent a process of determining whether the restored target image has been properly restored.

In an embodiment, the computing device 100 may evaluate the restoration accuracy by comparing the target object in the restored target image and the reference image at a pixel level. For example, the computing device 100 may determine the pixel accuracy for the restored target image by comparing, at a pixel level, a first pixel set representing the target object in the restored target image and a second pixel set representing the target object in the reference image. The computing device 100 may evaluate the restoration accuracy of the restored target image by using the pixel accuracy. In this example, the computing device 100 may generate an extraction result (e.g., a segmentation result) corresponding to the restored target image in order to extract the target object from the restored target image. This extraction result in the restored target image may be implemented through an object detection model and/or a segmentation model. The computing device 100 may reuse the target object (e.g., the second extraction result) extracted from the reference image in step 520 to evaluate the accuracy of the restored target image. The computing device 100 may determine how well (e.g., many) the pixels of the target object in the restored target image match the pixels of the target object in the reference image by comparing the extraction result in the restored target image and the second extraction result on a pixel-by-pixel basis. For example, the number of matching pixels and the restoration accuracy may have a positive correlation (e.g., a positive relationship).

In an embodiment, the computing device 100 may determine the restoration accuracy for the restored target image, by extracting a target object from the restored target image, extracting restored target feature points from the target object, extracting reference feature points from the target object of the reference image, and matching the restored target feature points and the reference feature points. In this example, the computing device 100 may generate an extraction result (e.g., a segmentation result) corresponding to the restored target image in order to extract the target object from the restored target image. This extraction result in the restored target image may be implemented through an object detection model and/or a segmentation model. The computing device 100 may detect the restored target feature points from the extraction result in the restored target image by using a feature point extraction model. The computing device 100 may reuse the target object (e.g., the second extraction result) extracted from the reference image in step 520 to evaluate the accuracy of the restored target image. The computing device 100 may reuse the feature points of the target object (i.e., reference feature points) extracted from the second extraction result in step 520 and/or 530 to evaluate the accuracy of the restored target image. The computing device 100 may generate a second comparison result including second transformation information that represents a distortion between the restored target image and the reference image, by matching the restored target feature points and the reference feature points. This second transformation information may represent a transformation matrix used to transform the restored target image into the reference image. By way of example and not limitation, this transformation matrix may include the aforementioned Affine matrix. The computing device 100 may evaluate the restoration accuracy of the restored target image by using the second transformation information. For example, the restoration accuracy of the target image may be evaluated by using the size of the noise region that occurs as a result of changing (e.g., restoring) the restored target image to the reference image using the second transformation information. Here, the size of the noise region and the restoration accuracy may have a negative correlation (or a negative relationship). In an additional embodiment, the computing device 100 may also evaluate the restoration accuracy of the target image by using the number of feature points that match each other with respect to pixel location among the reference feature points and the restored target feature points of the restored target image.

In an embodiment, the process related to the restoration accuracy evaluation may be operated to be performed only in a case where the distortion type is a second type corresponding to a small distortion. A technical effect can be derived in that the situation for performing the accuracy evaluation of the result of restoring the target image is clearly determined, thereby increasing the utility of the restoration accuracy evaluation and, furthermore, efficiently using the computing resources used to evaluate the restoration accuracy.

In an embodiment, the computing device 100 may adjust the distortion of the field of view of the target camera by replacing the target image with the restored target image, in a case where it is determined that the restoration accuracy exceeds a predefined threshold by comparing the restoration accuracy with the predefined threshold. For example, in a case where the distortion type of the field of view of the target camera is a small distortion type, the restoration accuracy for the restored target image is evaluated, and whether to adjust the distortion type of the field of view may be determined by replacing the restored image with the target image according to the level of the restoration accuracy.

In an embodiment, there may be a plurality of types of field of view distortion according to the quantitative level of the field of view distortion. There may be different field of view adjustment schemes for the camera. The computing device 100 may match the field of view distortion type with a field of view adjustment scheme. For example, there may be a first distortion type corresponding to a large distortion and a second distortion type corresponding to a small distortion. The computing device 100 may perform a different scheme of field of view adjustment for the target camera according to the identification of the distortion type.

For example, in a case where the distortion type is determined to be a first type corresponding to a large distortion, the computing device 100 may adjust the distortion of the field of view of the target camera by controlling a physical movement of the target camera or by generating an administrator notification. For example, in a case where the distortion type is determined to be a second type corresponding to a small distortion, the computing device 100 may adjust the distortion of the field of view of the target camera by performing a field of view correction process for the target image. For example, in a case where the distortion type is determined to be the first type corresponding to a large distortion, the computing device 100 may adjust the distortion of the field of view of the target camera by controlling a physical movement of the target camera or by generating an administrator notification. In a case where the distortion type is determined to be a second type corresponding to a small distortion, the computing device 100 may adjust the distortion of the field of view of the target camera by generating a restored target image corresponding to the target image.

In an embodiment, the process of generating the first extraction result and the second extraction result, the process of determining whether a field of view distortion exists, and/or the process of determining the distortion type may be periodically performed according to a first period. The process of adjusting the distortion of the field of view may be operated according to a different period depending on the distortion type of the field of view. The execution period of the process of adjusting the distortion of the field of view may be dynamically changed according to the distortion type of the field of view. For example, in a case where the type of the distortion of the field of view is a first type, the process of adjusting the distortion of the field of view may be periodically performed according to a first period. For example, in a case where the type of distortion of the field of view is a second type, the process of adjusting the distortion of the field of view may be periodically performed according to a second period that is smaller than the first period. For example, in a case where the type of the distortion of the field of view is determined to be a small distortion, the process of adjusting the distortion of the field of view is periodically performed according to a first period, and in a case where the type of the distortion of the field of view is determined to be a large type, the process of adjusting the distortion of the field of view may be periodically performed according to a second period that is shorter than the first period.

In an embodiment, whether to stop the periodically performed process of adjusting the distortion of the field of view may be determined according to whether a region of interest for the target camera is set or reset. For example, in response to the distortion type of the field of view being determined as a small distortion type, the process of adjusting the distortion of the field of view is repeatedly performed for each of the periodically received target images. Furthermore, the computing device 100 may replace the target image, by using a restored target image generated by applying the comparison result between the target image and the reference image to the target image. Various applications related to an intelligent transportation system, such as traffic volume extraction and/or traffic volume analysis, may be executed using the replaced target image. For example, in response to the distortion type being determined as a small distortion type, the computing device 100 may generate an adjusted region of interest for the target camera by using the comparison result between the reference image and the target image. For example, the adjusted region of interest may be generated by using the replaced target image described above. For example, the adjusted region of interest may be generated based on the region of interest within the reference image and the transformation matrix (or the replaced target image). For example, an adjusted region of interest corresponding to the target image may be generated by applying the transformation matrix to the region of interest. The computing device 100 may stop the periodically performed adjustment of the field of view distortion in response to the region of interest for the target camera being reset based on the adjusted region of interest.

In an embodiment, the computing device 100 may automatically adjust the distortion of the field of view by using a different field of view adjustment scheme according to the distortion type of the target camera.

As described above, a technique according to an embodiment of the present disclosure can automatically recognize a distortion of a field of view and achieve automation of distortion correction, based on field of view information acquired from a target image. Because existing technology determines whether a field of view is abnormal according to outliers in the result data collected and processed after detection on an image, it may have a problem which cannot effectively and preemptively determine an abnormal field of view situation, in that it uses secondary data (a normal or abnormal determination result for the processing result at the application level for an image) and not the field of view data for a source image. A technique according to embodiments of the present disclosure can determine an abnormal situation of a field of view in a more efficient manner based on the field of view information from a source image, and furthermore can automatically control and adjust the abnormal situation of the Field of view. A technique according to embodiments of the present disclosure can achieve a technical effect in that maintenance due to an abnormality of a camera's field of view within a control system can be automated, and accordingly, the efficiency of control can be increased. Furthermore, a technique according to embodiments of the present disclosure can detect an abnormal situation of a field of view at an early stage and furthermore can strengthen the reliability of the collected data.

FIG. 6 shows an exemplary flowchart for determining a reference image, according to an embodiment of the present disclosure.

At least a part of the steps illustrated in FIG. 6 may be performed by the computing device 100.

The reference image in the present disclosure, as an image assigned to a target camera, may mean an image that serves as a standard or a criteria for comparison with a target image. The reference image may mean an image in a situation where a field of view distortion of a corresponding camera does not exist. The reference image, as an image to be compared with a target image, may represent an image pre-assigned to a target camera. The reference image may mean an image that represents a region of interest (ROI) of a target camera. For example, in a control system where a plurality of cameras exist, a first reference image may be assigned to a first camera, a second reference image may be assigned to a second camera, and a third reference image may be assigned to a third camera.

In an embodiment, the reference image corresponding to a camera may be determined at the time a user determines settings (or configurations) (e.g., setting a region of interest) related to the field of view of an image analysis model and/or an image analysis application

In an embodiment, the computing device 100 may receive a plurality of sample images captured by a target camera (610).

In an embodiment, the reference image may be pre-assigned to the target camera before acquiring the target image.

In an embodiment, the computing device 100 may obtain a plurality of sample images from the target camera. The sample images in FIG. 6 may correspond to candidate images for determining the reference image.

In an embodiment, the computing device 100 may generate verification results corresponding to the plurality of sample images by using one sample image among the plurality of sample images and the remaining sample images other than the one sample image (620).

For example, the computing device 100 may perform, for each of the plurality of sample images, a process of comparing a first sample image with the remaining sample images, comparing a second sample image with the remaining sample images, and comparing a third sample image with the remaining sample images. A sample image to be selected as the reference image from among the plurality of sample images may be determined by using the verification result generated through this comparison procedure. For example, one verification result may be generated for one sample image. One verification result may represent a comparison result (e.g., a total sum and/or an average value, etc.) between one sample image and other sample images.

In an embodiment, the comparison between sample images and/or the generation of a verification result may be performed by using the process for determining the field of view distortion illustrated, for example, in FIG. 5 (e.g., reference numerals 520, 530, and 540).

In an embodiment, the comparison between sample images and/or the generation of a verification result may be performed by using the process for determining the distortion type of the field of view illustrated, for example, in FIG. 5.

In an embodiment, the comparison between sample images and/or the generation of a verification result may be performed through a process of generating a transformation matrix between the sample images and generating a quantitative value for the transformation matrix.

In an embodiment, the computing device 100 may generate extraction results that extract a target object from each of the plurality of sample images. For example, extraction results (e.g., object detection results and/or segmentation results) that extract a target object (e.g., a road object) from each of the plurality of sample images may be generated by using an artificial intelligence model (e.g., an object detection model and/or a segmentation model) to which each of the plurality of sample images is input. The computing device 100 may generate a verification result for each of the plurality of sample images in a manner of comparing the extraction results. For example, the computing device 100 may generate a verification result corresponding to a first sample image by extracting a first target object from the first sample image and comparing the first target object with a second target object extracted from a second sample image, a third target object extracted from a third sample image, and an Nth target object extracted from an Nth sample image (wherein N is a natural number). The verification result may represent a magnitude of distortion with other sample images for each of the plurality of sample images. A sample image with the smallest total sum or average value of the magnitude of distortion with other sample images may be selected as the reference image from among the plurality of sample images.

In an embodiment, from among the extraction results obtained from each of the plurality of sample images, sample images having an extraction result in which a proportion occupied by the target object within an image is smaller than a predetermined threshold ratio may be excluded in generating the verification results. For example, in a case where a first sample image exists having an extraction result in which the proportion occupied by the target object is smaller than a predetermined threshold ratio among the plurality of sample images, this first sample image may be excluded when performing the comparison process with other sample images. Therefore, when performing the comparison process for each of the other sample images, the first sample image may not be a subject of comparison. In the example above, a target object for the first sample image is extracted, it is determined whether an area of the target object within the image is less than a threshold value, and it may be determined that the first sample image corresponding to being less than the threshold value is excluded without performing a comparison with other images.

In an embodiment, it is advantageous for a later field of view distortion detection and/or field of view distortion correction that the reference image is selected as an image that preserves the road area as much as possible. Therefore, in a case where a size of an area occupied by other objects other than the target object (or a proportion occupied by the corresponding area within the image) in an extraction result (e.g., a segmentation result) of the target object for a sample image exceeds a threshold size (or a threshold ratio), the computing device 100 may determine to exclude the corresponding sample image from the comparison process (or verification process).

As described above, the computing device 100 may determine whether each of the sample images can be a subject of verification, by using a size of an area occupied by a target object and/or a size of an area occupied by other objects other than the target object, from the result of extracting the target object for each of the plurality of sample images. The target objects extracted from the sample images that are subjects of verification may be compared, and the reference image may be determined from among the sample images.

In an embodiment, the computing device 100 may determine the reference image corresponding to the target camera from among the plurality of sample images by using the verification results (630).

In an embodiment, the computing device 100 may determine a sample image corresponding to a verification result with the smallest magnitude of distortion among the verification results corresponding to each of the plurality of sample images, as the reference image corresponding to the region of interest of the target camera.

The reference image determined through the method illustrated in FIG. 6 may be used as the image for comparison with a target image.

The sample image used to determine the reference image in the present disclosure and the sample image provided to a user in the process of determining whether a field of view distortion of the target camera exists may be different images.

FIG. 7 illustratively shows a methodology for determining a reference image, according to an embodiment of the present disclosure.

In an embodiment, N sample images (Sample 1, 2, 3 . . . n) may be obtained from a target camera. Here, N corresponds to a natural number of 2 or more.

As illustrated in FIG. 7, Sample 1 is compared with each of n−1 other sample images (reference numeral 701), and as a result of the comparison, the difference between Sample 1 and each of the n−1 other sample images may be quantified (3). Sample 2 is also compared with each of n−1 other sample images (reference numeral 702), and as a result of the comparison, the difference between Sample 2 and each of the n−1 other sample images may be quantified (1.2). Sample 3 is also compared with each of n−1 other sample images (reference numeral 703), and as a result of the comparison, the difference between Sample 3 and each of the n−1 other sample images may be quantified (3.6). Sample n is also compared with each of n−1 other sample images (reference numeral 704), and as a result of the comparison, the difference between Sample n and each of the n−1 other sample images may be quantified (2.4).

In an embodiment, the comparison between the sample images may include a process of comparing feature points of target objects extracted from each of the sample images. As a result of comparing the feature points, a transformation matrix representing the distortion between the sample images may be generated. By quantifying this transformation matrix, the result of the comparison between the sample images may be quantified. Here, the comparison between the feature points may be performed by matching the feature points using descriptors assigned to the feature points, and a transformation matrix may be generated by using the difference in pixel position values between the matched feature points. This transformation matrix may include transformation information or a transformation value that is applied to match one image to another. Accordingly, by quantifying the values of the n−1 transformation matrices into a single value, a comparison result or a verification result for each of the sample images may be generated.

In an additional embodiment, the comparison between the sample images may include a process of comparing the target objects extracted from each of the sample images at a pixel level. As a result of the pixel-level comparison, a transformation matrix representing the distortion between the sample images may be generated. By quantifying this transformation matrix, the result of the comparison between the sample images may be quantified.

In the example in FIG. 7, it is illustrated that the comparison result between the sample image corresponding to Sample 2 and the other sample images has the smallest value among the comparison results of the other sample images. Accordingly, the computing device 100 may set the sample image corresponding to Sample 2 as the reference image corresponding to the target camera. In a case where the reference image is set, a region of interest (e.g., an area that the target camera intends to capture) corresponding to the target camera may be set within the reference image.

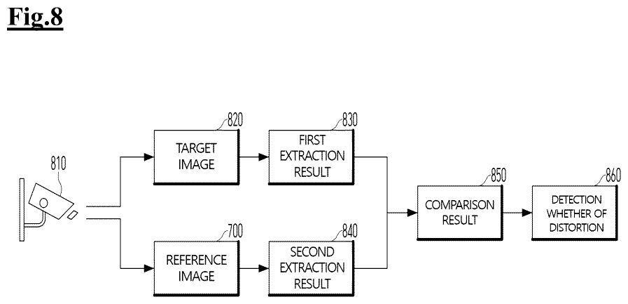

FIG. 8 shows an exemplary methodology for detecting whether or not a distortion of a field of view has occurred, according to an embodiment of the present disclosure.

In an embodiment, the computing device 100 may receive a target image 820 from a target camera 810. For example, the target image 820 may represent an image obtained by capturing of the target camera 810 after a reference image 700 corresponding to the target camera 810 has been set. The target image 820 may be an image used to determine the distortion of the field of view of the target camera 810. The target image 820 may be an image used to determine the distortion of the field of view of the target camera 810 and to adjust the distortion of the field of view of the target camera 810. The target image 820 may be used to determine the distortion of the field of view of the target camera 810, used to adjust the distortion of the field of view of the target camera 810, and/or used to detect a traffic-related event within the region of interest of the target camera 810.

In an embodiment, the computing device 100 may obtain the reference image 700 assigned to the target camera 810. The reference image 700 is the subject of comparison with the target image 820 and may mean an image in a state where there is no distortion of the target camera 810.

In an embodiment, the computing device 100 may generate a first extraction result 830 from the target image 820. For example, the first extraction result 830 may be generated by using a pre-trained artificial intelligence model that takes an image as input and outputs a segmentation result of a predefined target object segmented within the image.

In an embodiment, the computing device 100 may generate a second extraction result 840 from the reference image 700. For example, the second extraction result 840 may be generated by using a pre-trained artificial intelligence model that takes an image as input and outputs a segmentation result of a predefined target object segmented within the image.

In an embodiment, the target image 820 and the reference image 700 may be respectively input to the same segmentation model, and the first extraction result 830 and the second extraction result 840, which include a target object corresponding to a road object and in which regions other than the target object are masked, may be generated from the segmentation model, respectively. For example, for the pixels in the masked regions, the pixel value may be processed as 0.

In an embodiment, the computing device 100 may generate a comparison result 850 by comparing the first extraction result 830 and the second extraction result 840. For example, the comparison result 850 may represent a result of comparing the feature points of the target object in the first extraction result 830 and the feature points of the target object in the second extraction result 840. To generate the comparison result 850, an artificial intelligence model (e.g., a feature point extraction model) that takes the first extraction result 830 as input and extracts feature points corresponding to the target object of the first extraction result 830 may be used. To generate the comparison result 850, an artificial intelligence model (e.g., a feature point extraction model) that takes the second extraction result 840 as input and extracts feature points corresponding to the target object of the second extraction result 840 may be used.

In an embodiment, a rule-based computer vision algorithm may be used to generate the comparison result 850. For example, SIFT (Scale Invariant Feature Transform), SURF (Speeded-Up Robust Features), and/or ORB (Oriented FAST and Rotated BRIEF), etc., may be used to extract the feature points of the first extraction result 830 and/or the second extraction result 840 and/or to compare them.

In an embodiment, as a result of the comparison 850 of the feature points, a transformation matrix (e.g., an Affine transformation matrix) representing the distortion between the target image 820 and the reference image 700 may be generated. In a case where the transformation matrix is applied to the target image 820, the distortion of the target image 820 may be adjusted or restored to match the reference image 700.

In an embodiment, the computing device 100 may detect whether a distortion of the target camera 810 exists (860) by using the comparison result 850. For example, the computing device 100 may detect whether a distortion of the target camera 810 exists (860) by comparing the comparison result 850 with a predefined threshold. For example, the computing device 100 may determine whether a value obtained from the transformation matrix is greater than a predefined threshold, and if it is greater than the threshold, it may determine that a distortion of the field of view of the target image 820 exists. The computing device 100 may determine whether a value obtained from the transformation matrix is greater than a predefined threshold, and if it is less than or equal to the threshold, it may determine that a distortion of the field of view of the target image 820 does not exist.

In an embodiment, a methodology for the computing device 100 to determine a predefined threshold is illustrated. The computing device 100 may provide a plurality of sample images received from the target camera 820 to a user. The computing device 100 may receive a result from the user that classifies a first sample image without a field of view distortion and a second sample image with a field of view distortion from among the plurality of sample images. For example, the first sample image and the second sample image, visually classified by a user who was provided with the plurality of sample images, may be obtained. The computing device 100 may calculate transformation matrices 850 for the target image 820 or the reference image 700 for each of the sample images, and may determine a threshold to be used to detect whether a distortion exists for the target image 820 by using the classification result received from the user and/or the transformation matrices 850.

In an embodiment, a methodology for the computing device 100 to determine a predefined threshold is illustrated. An image with a distortion and an image without a distortion may be distinguished by a user by using previously secured field of view change images (e.g., images in which field of view is changed). The computing device 100 may detect the level of field of view distortion with a reference image 700 (e.g., an image without distortion) assigned to the target camera 810 by using the distinguished images. Detecting this level of field of view distortion may include, as described above, a method of extracting the distorted transformation matrix value that each sample image has by using transformation information (e.g., a transformation matrix) between the images. The computing device 100 may determine a criterion for determining the presence or absence of a distortion, that best distinguishes the values of the distorted transformation matrices possessed by a sample image without distortion and a sample image with distortion. For example, the computing device 100 may determine, as a criterion, a single value that best distinguishes between a sample image with a distortion and a sample image without a distortion, as previously distinguished by a person, based on a shift value and/or a rotation value among the values included in the transformation matrix. The computing device 100 may detect whether a distortion of the target image 820 exists (860) by comparing the value of the transformation matrix obtained for the target image 820 with the criterion. It is determined that a distortion of the target image 820 exists if the value of the transformation matrix obtained for the target image 820 is greater than the criterion, and it is determined that a distortion of the target image 820 does not exist if the value of the transformation matrix obtained for the target image 820 is less than or equal to the criterion.

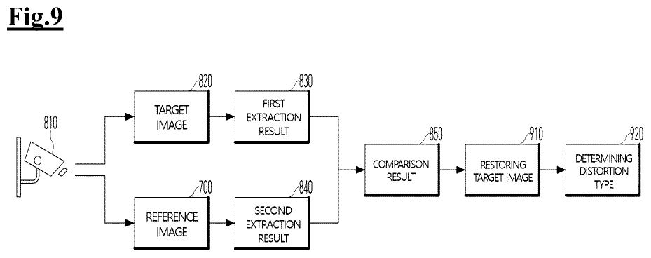

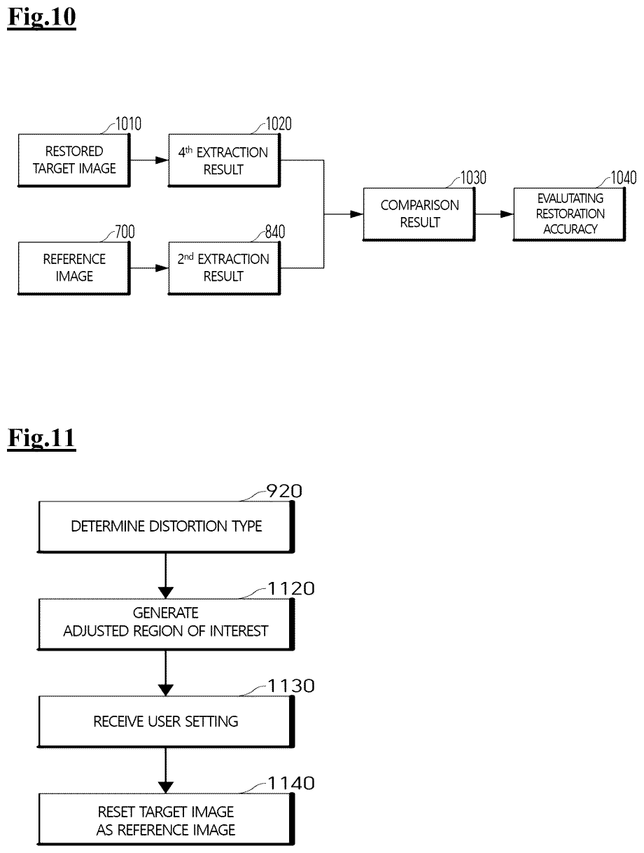

FIG. 9 shows an exemplary methodology for determining a distortion type of a field of view according to an embodiment of the present disclosure.

In an embodiment, the computing device 100 may generate a comparison result 850 for a target image 820 and a reference image 700 by using the method described above in FIGS. 5 to 8.

In an embodiment, the computing device 100 may use the comparison result 850 to restore (910) the target image 820. Restoring (910) the target image 820 may include applying a transformation matrix obtained through the comparison result 850 to the target image 820 to change the target image 820, such that the target image 820 can match the reference image 700.

In an embodiment, restoring (910) the target image 820 may include performing an angle correction for the target image 820 by applying a transformation matrix obtained through the comparison result 850 to the target image 820. For example, restoring (910) the target image 820 may include rotating the target image 820 by an angle according to a rotation matrix by applying the transformation matrix (e.g., a rotation matrix) to the target image 820. For example, this rotation may include a two-dimensional rotation and/or a three-dimensional rotation.

In an embodiment, the computing device 100 may determine a predetermined center of rotation (e.g., a pivot point) to restore (910) the target image 820. For example, the predetermined center of rotation may be determined as a point that has a large difference from the target object of the reference image 700 as a result of comparison with the reference image 700. For example, the predetermined center of rotation may be determined as the center point of the target image 820. For example, the predetermined center of rotation may be determined as an arbitrary point or a center point of a predetermined feature (e.g., a road object) in the target image 820.

In an embodiment, the computing device 100 may determine the coordinates to which the feature points or pixels of the target image 820 will be changed, by applying a rotation matrix included in the transformation matrix generated according to the comparison result 850 to the target image 820, and may restore the target image 820 by changing the feature points or pixels of the target image 820 to the changed coordinates.

In an embodiment, the computing device 100 may also restore the target image 820 to correspond to the reference image 700 by using both a rotation value and a translation value (or a rotation vector and a translation vector) included in the transformation matrix.

In an embodiment, the computing device 100 may generate a restored target image by using a method of rearranging or interpolating the pixels or feature points of the target image 820 according to the transformed coordinates or rotated coordinates.

In an embodiment, the computing device 100 may determine the distortion type of the field of view of the target camera 810 by using the restored target image (920).

In an embodiment, the determination of the distortion type of the field of view may be performed in a case where it is detected that there is a field of view distortion.

In an embodiment, the distortion type of the field of view may include a plurality of distortion types. The distortion type of the field of view may be classified into a plurality of distortion types according to the level of distortion. For example, a large distortion representing a first type may mean a situation where the region of interest (ROI) of an image is affected by a field of view distortion, so that even if the computing device 100 performs a distortion correction or adjustment on its own, it affects (e.g., impacts) the detection and/or generation of object information within the region of interest. A distortion corresponding to the first type may represent a situation where normal image analysis is difficult even if a correction or adjustment for the field of view distortion is performed on its own by the computing device 100. For example, a small distortion representing a second type may mean a situation where the region of interest (ROI) of an image is not impacted by a field of view distortion, so that the computing device 100 can perform a distortion correction or adjustment on its own while unaffecting the detection and/or generation of object information within the region of interest. In such cases, the computing device 100 can perform distortion correction or adjustment autonomously without impacting the detection and/or generation of object information within the ROI

In an embodiment, the computing device 100 may determine the distortion type of the field of view of the target camera 810 by using the size of a margin (e.g., a noise region) that occurs according to the restoration result in the restored target image. For example, the computing device 100 may determine the distortion type of the field of view of the target camera 810 by comparing the size of the noise region that occurred (or generated) according to the restoration result in the restored target image and the size of the restored target image. For example, the computing device 100 may determine the distortion type of the field of view of the target camera 810 by comparing a ratio that the noise region that occurred according to the restoration result occupies in the restored target image with a threshold ratio. For example, when the ratio that the noise region occupies in the entire area of the restored target image is 0.2 or more, the computing device 100 may determine that the distortion type of the field of view of the target camera 810 is the first type, and otherwise, it may determine that the distortion type of the field of view of the target camera 810 is the second type.

In an embodiment, the computing device 100 may determine the distortion type of the field of view of the target camera 810 by comparing a margin (e.g., a noise region) that occurs according to the restoration result in the restored target image with the region of interest (ROI) in the corresponding image. For example, the distortion type of the field of view of the target camera 810 may be determined according to whether an overlapping region exists between the margin (e.g., a noise region) and the region of interest. For example, in a case where an overlapping region exists between the margin (e.g., a noise region) and the region of interest, the distortion type may be determined as a first distortion type representing a large distortion. For example, in a case where an overlapping region does not exist between the margin (e.g., a noise region) and the region of interest, the distortion type may be determined as a second distortion type representing a small distortion.

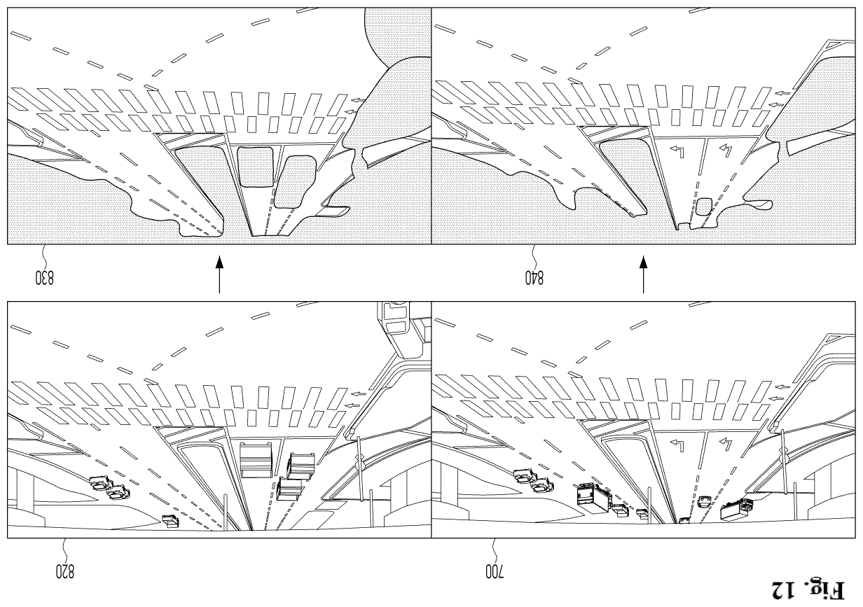

FIG. 10 shows an exemplary methodology for evaluating a recovery accuracy of a target image, according to an embodiment of the present disclosure.

In an embodiment, the computing device 100 may generate a fourth extraction result 1020 that extracts a target object (e.g., a road region) from a restored target image 1010. For example, the fourth extraction result 1020 may be generated by using a method corresponding to the method of generating the aforementioned extraction results (e.g., the first extraction result, the second extraction result, and/or the third extraction result). For example, the fourth extraction result 1020 may be generated by using an artificial intelligence model that takes the restored target image 1010 as input and outputs a target object within the restored target image 1010. For example, the fourth extraction result 1020 may be generated by using an artificial intelligence model that takes a target object extracted from the restored target image 1010 as input and outputs feature points corresponding to the target object.

In an embodiment, the computing device 100 may generate a second extraction result 830 that extracts a target object (e.g., a road region) within a reference image 700 from the reference image 700. In an embodiment, the second extraction result 830 may be generated in advance in the comparison process of the target image and the reference image 700 (e.g., see FIGS. 5 to 9), and the computing device 100 may reuse the second extraction result 830 generated in the corresponding process in the comparison step of FIG. 9. In an embodiment, the computing device 100 may extract feature points corresponding to the target object from the target object in the reference image 700. These feature points also may be generated in advance in the comparison process of the target image and the reference image 700 (e.g., see FIGS. 5 to 9), and the computing device 100 may reuse the feature points obtained in the corresponding process in the comparison step of FIG. 9.

In an embodiment, the computing device 100 may generate a comparison result 1030 by comparing the fourth extraction result 1020 and the second extraction result 840. The computing device 100 may extract feature points corresponding to the target object from the fourth extraction result 1020. The computing device 100 may extract feature points corresponding to the target object from the second extraction result 840. The computing device 100 may generate the comparison result 1030 by comparing the extracted feature points.

In an embodiment, the computing device 100 may generate transformation information between the restored target image 1010 and the reference image 700 by comparing feature points obtained from (or included in) the fourth extraction result 1020 and feature points obtained from (or included in) the second extraction result. The transformation information may, for example, include a transformation matrix. The transformation matrix may, for example, include a translation vector and/or a rotation vector. The transformation matrix may, for example, include an Affine transformation matrix.

The extraction of a target object, the extraction of feature points, the comparison of feature points, and/or the generation of transformation information will be replaced by the descriptions detailed above in FIGS. 5 to 9.

In an embodiment, the computing device 100 may evaluate (1040) the restoration accuracy of the target image by using the comparison result 1030.

For example, the computing device 100 may evaluate (1040) the restoration accuracy of the restored target image by using transformation information obtained according to the comparison result 1030. In this example, the restoration accuracy may be evaluated in a manner of comparing the magnitude of a quantified value from the transformation information with a threshold. If the magnitude of the quantified value is greater than the threshold, the restoration accuracy may be evaluated as low. The magnitude of the quantified value and the restoration accuracy may have a negative correlation.

For example, the computing device 100 may evaluate (1040) the restoration accuracy of the restored target image by comparing the feature points of the target objects. In this example, the computing device 100 may compare the reference image and the restored target image in a manner of matching the feature points of the target objects. The computing device 100 may generate a comparison result 1030 that includes transformation information representing a distortion between the restored target image 1010 and the reference image 700 by matching restored target feature points representing the target object in the restored target image 1010 with reference feature points from the second extraction result 840, and may evaluate (1040) the restoration accuracy of the restored target image 1040 by using the transformation information included in the comparison result 1030. This restoration accuracy evaluation method may be performed in a manner corresponding to the methodology for detecting the field of view distortion described above.

For example, the computing device 100 may determine the pixel accuracy for the restored target image 1010 by comparing, at a pixel level, a first pixel set representing the target object in the restored target image 1010 and a second pixel set representing the target object in the reference image 700, and may evaluate (1040) the restoration accuracy of the restored target image 1010 by using the pixel accuracy. In this example, the computing device 100 may perform a pixel accuracy measurement for the road corresponding to the restored target image 1010 by using the segmentation result of the restored target image 1010 and the segmentation result of the reference image 700. The pixel accuracy measurement may be performed by dividing the pixels corresponding to the road region of the restored target image 1010 by the pixels where the road region of the reference image 700 and the road region of the restored target image 1010 overlap. The pixel accuracy measurement may be performed by dividing the pixels corresponding to the road region of the restored target image 1010 by the pixels where the road region of the reference image 700 and the black region (e.g., a margin region or a noise region, etc.) of the restored target image 1010 overlap.

In an embodiment, the computing device 100 may also evaluate the restoration accuracy more accurately by combining the method of evaluating pixel accuracy and the method of matching feature points.

FIG. 11 illustratively shows a methodology for generating an adjusted region of interest and for using the generated region of interest, according to an embodiment of the present disclosure.

In an embodiment, the computing device 100 may determine (920) the distortion type of the field of view of a target camera. For example, the computing device 100 may determine the level of field of view distortion of the target camera by using the result of restoring a target image obtained from the target camera. For example, the computing device 100 may determine a first distortion type corresponding to a large distortion and/or a second distortion type corresponding to a small distortion, according to the level of field of view distortion of the target camera, determined by using the result of restoring the target image obtained from the target camera. The features related to the determination (920) of the distortion type will be replaced by the content described above.

In an embodiment, after determining (920) the distortion type of the field of view of the target camera, the computing device 100 may generate an adjusted region of interest (1120). For example, the computing device 100 may generate an adjusted region of interest in the target image by using the comparison result for the target image and a reference image (1120). The adjusted region of interest may represent the area that the target camera intends to observe in the target image whose field of view is partially misaligned or distorted. For example, the computing device 100 may generate an adjusted region of interest in a restored target image by using the comparison result for the target image and the reference image (1120). The adjusted region of interest may represent the area that the target camera intends to observe in the restored target image. For example, the computing device 100 may automatically set a new region of interest for the target image or the restored target image according to the degree or type of field of view distortion. For example, the computing device 100 may transmit the degree of field of view distortion to a user, and transmit a new setting, which corrects the existing setting for the region of interest based on the changed field of view, to the user.

In an embodiment, the process of generating an adjusted region of interest may be performed by using an artificial intelligence model that takes a pre-set region of interest for the target camera (e.g., an existing region of interest) and a comparison result between the target image and the reference image as input, and outputs the adjusted region of interest. In an embodiment, the process of generating an adjusted region of interest may be performed in a case where the distortion type of the field of view is a second type representing a small distortion, and may not be performed in a case where the distortion type of the field of view is a first type representing a large distortion. Accordingly, in the case of a large distortion, an additional process such as controlling the camera may be performed without automatically setting the region of interest by the computing device 100. Accordingly, in the case of a small distortion, a technical effect can be achieved in that the transportation control system can operate in a resource-efficient manner as the region of interest for detecting traffic conditions is automatically reset even in a situation where the camera's field of view is partially misaligned or distorted, by resetting the region of interest for the target image (or the restored target image) by the computing device 100.

In an embodiment, the computing device 100 may receive a user setting in which a user sets the adjusted region of interest as the region of interest for the target camera (1130). In an embodiment, the computing device 100 may receive a user setting in which a user sets a region of interest, which is a partially adjusted version of the adjusted region of interest, as the region of interest for the target camera (1130).

In an embodiment, in response to receiving (1130) the user setting, the computing device 100 may reset the target image or the restored target image as the reference image corresponding to the target camera (1140). In an embodiment, in response to the region of interest for the target camera being reset based on the adjusted region of interest, the computing device 100 may determine to stop the repeatedly performed process of adjusting the field of view distortion. For example, in a case where the region of interest for the target camera is reset based on the adjusted region of interest, the computing device 100 can determine to stop the field of view adjustment process using the distortion information, thereby allowing the computing resources used for the field of view adjustment process to be utilized efficiently.

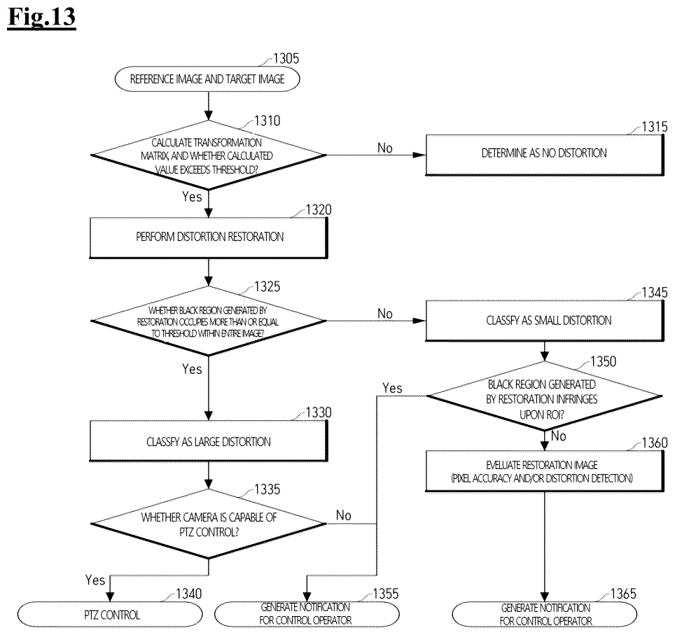

FIG. 12 illustratively shows a methodology for comparing extraction results extracted from a reference image and a target image, according to an embodiment of the present disclosure.

In an embodiment, an extraction result (e.g., a segmentation result) 840, in which a target object (e.g., a road object) is included and non-target objects are masked within a reference image 700 based on the reference image 700, is illustrated in FIG. 12. As illustrated in reference numeral 840, only the target object representing a road is included in the extraction result 840, and the remaining objects other than the road may be excluded from the extraction result 840.

In an embodiment, an extraction result (e.g., a segmentation result) 830, in which a target object (e.g., a road object) is included and non-target objects are masked within a target image 820 based on the target image 820, is illustrated in FIG. 12. As illustrated in reference numeral 830, only the target object representing a road is included in the extraction result 830, and the remaining objects other than the road may be excluded from the extraction result 830.

In an embodiment, the computing device 100 may compare the feature points of the extraction results 830 and 840 where only the road object remains. For example, the computing device 100 may perform matching between the feature points extracted from the extraction results 830 and 840 and generate a transformation matrix by utilizing the matched feature points. The computing device 100 may extract a transformation matrix value from within the transformation matrix. This transformation matrix and/or transformation matrix value may be used in detecting a field of view distortion, in evaluating the distortion type of a field of view, in restoring a target image, in evaluating a restored target image, and/or in determining a reference image. Accordingly, a technical effect can be achieved in that the reference image 700 and the target image 820 can be compared in a more resource-efficient and highly accurate manner.

FIG. 13 shows an exemplary flowchart for distinguishing a field of view distortion and adjusting the distortion of a field of view, according to an embodiment of the present disclosure.

In an embodiment, the computing device 100 may receive a reference image and a target image (1305). For example, the computing device 100 may obtain a target image that is the subject of monitoring for field of view distortion from a target camera, and obtain a reference image corresponding to an image where there is no field of view distortion, which is mapped to the target camera.

In an embodiment, the computing device 100 may calculate a transformation matrix for changing the target image to the reference image by comparing the reference image and the target image. The computing device 100 may calculate a transformation matrix representing the field of view distortion of the target image with respect to the reference image by comparing the reference image and the target image. When calculating the transformation matrix, the computing device 100 may compare the extraction result of the target object for the target image and the extraction result of the target object for the reference image. When calculating the transformation matrix, the computing device 100 may compare target feature points extracted from the target object for the target image and reference feature points extracted from the target object for the reference image. The comparison of the target feature points and the reference feature points may be performed in a manner of comparing the pixel coordinates corresponding to each of the feature points. The comparison of the target feature points and the reference feature points may be performed in a manner of mapping the feature points using descriptors corresponding to each of the feature points and then comparing the pixel coordinates of the mapped feature points. The computing device 100 may quantitatively calculate the difference between the pixel coordinates of the mapped feature points. For example, the difference between the pixel coordinates of the mapped feature points may be calculated by a distance calculation between two-dimensional coordinates.

The computing device 100 may determine whether the value of the transformation matrix exceeds a predefined threshold (1310). For example, the computing device 100 may use a criterion, determined to distinguish the values of transformation matrices of an image with a distortion and an image without a distortion, as the predefined threshold. Whether a distortion of the target image exists may be determined as the transformation matrix value extracted from the transformation matrix is compared with the predefined threshold. If the transformation matrix value extracted from the transformation matrix does not exceed the predefined threshold, it may be determined that no distortion of the target image exists (1315). If the transformation matrix value extracted from the transformation matrix exceeds the predefined threshold, it may be determined that a distortion of the target image exists, and accordingly, it may be determined to proceed with a distortion restoration for the target image (1320). For example, the transformation matrix value extracted from the transformation matrix may be determined by using the values included in a two-dimensional matrix.

The computing device 100 may perform a distortion restoration for the target image in a manner as illustrated in FIGS. 5 to 9. The computing device 100 may generate a restored target image through the distortion restoration. The restored target image may be generated by applying the transformation matrix to the target image.

The computing device 100 may determine whether a black region (e.g., a noise region) generated by the restoration in the restored target image occupies more than a certain threshold within the entire image (1325). If it is determined that the size of the black region is greater than or equal to a certain threshold within the entire image (e.g., the restored image), the target image may be determined to be an image with a large distortion (1330). If it is determined that the size of the black region is less than a certain threshold within the entire image (e.g., the restored image), the target image may be determined to be an image with a small distortion (1345).

If the computing device 100 determines that the target image has a large distortion, it may determine whether the target camera is a camera capable of PTZ (Pan, Tilt, and Zoom) control (1335). For example, a camera capable of PTZ control may mean a camera equipped with a function that can remotely adjust the direction and zoom of the camera lens. Here, PTZ may be used to encompass Pan, which represents the function of the camera rotating left and right, Tilt, which represents the function of the camera rotating up and down, and Zoom, which represents the function of enlarging (e.g., zoom in) or reducing (e.g., zoom out) the camera's lens.

A technique according to an embodiment of the present disclosure may present a field of view correction scenario that is adaptive to the type of camera. In a case where the camera is one that can change its field of view by itself, a process of returning to the original field of view (preset field of view) or changing to an adjusted field of view may be performed by transmitting a separate command to the corresponding camera remotely. In a case where the camera is one that cannot change its field of view by itself, a maintenance plan for the corresponding camera may be established by providing a notification to a user in the control center.

If the target camera is a camera capable of PTZ control, the computing device 100 may perform PTZ control for the target camera (1340). For example, the PTZ control of the camera may be performed by the computing device 100 with the value according to the transformation matrix. For example, the computing device 100 may control the Pan, Zoom, and Tilt of the target camera according to a two-dimensional transformation matrix. As the target camera is remotely PTZ controlled, the problem of the field of view distortion for the target camera can be automatically resolved. Accordingly, a technique according to an embodiment of the present disclosure can detect the presence of a distortion of a target camera in response to receiving a target image from the target camera, detect the distortion type of the target camera, and if the distortion type of the target camera is determined to be a large distortion, remotely control the PTZ camera by using the transformation matrix used in the distortion analysis process of the target camera.

If the computing device 100 determines that the target camera is not capable of PTZ control, it may generate a notification to be provided to a control operator. Accordingly, the computing device 100 may allow the control operator to access the target camera and perform processes such as physical adjustment for the target camera.

In a case where the computing device 100 determines in step 1345 that the target camera corresponds to a small distortion from the target image of the target camera, it may determine whether the black region generated by the restoration of the target image infringes upon (e.g., invades or encroaches or intrudes into) the region of interest assigned to the reference image (or the target image). If the noise region generated by the restoration of the target image overlaps with the region of interest that the target camera is aimed at, a problem may occur in the traffic-related control operation of the target camera. Accordingly, even if the distortion type of the target camera corresponds to a small distortion, if the result of restoring the target image via software overlaps with the region of interest of the target camera, the computing device 100 may generate a notification to be sent to a control operator without adjusting or correcting the target image via software (1355).

If the computing device 100 determines that the black region generated by the restoration does not infringe upon the region of interest of the target camera, it may perform an evaluation for the restored target image (1360). For example, the evaluation for the restored target image may be performed in a case where the distortion type for the target camera is determined to be a small distortion. In a situation of a large distortion, the evaluation process for the restored target image is not performed, and accordingly, a technical effect can be achieved in that the computing resources used for the evaluation process can be used efficiently. For example, the evaluation for the restored target image may be performed in a case where the noise region within the restored target image does not overlap with the region of interest of the target camera. Because the evaluation process is not performed in a case where the noise region within the restored target image overlaps with the region of interest of the target camera, a technical effect can be achieved in that the computing resources used for the evaluation process can be used efficiently. The evaluation for the restored target image will be replaced by the content described in FIGS. 5 to 10 above. The computing device 100 may generate notification information to deliver the evaluation result for the restored image to a control operator (1365).

As illustrated in FIG. 13, a technique according to an embodiment of the present disclosure, in a case where the distortion type of a field of view according to the analysis of a target image is determined to be a large distortion and in a case where the black margin existing in the restored target image and the region of interest overlap, can achieve more accurate and efficient abnormal situation monitoring of an intelligent control system by providing a warning notification to a user.

A technique according to an embodiment of the present disclosure organically combines the content of determining whether a field of view distortion exists for a received target image, restoring the target image to determine the distortion type of the field of view if a field of view distortion exists, applying a different scheme of field of view adjustment process according to the distortion type, and providing a user with a scenario related to the resetting of a region of interest and/or a reference image by using the restoration result for the target image. Accordingly, the automation of an intelligent control system is achieved, the distortion phenomenon of a camera due to the external environment can be adjusted in a resource-efficient manner, and furthermore, the user experience of the intelligent control system can be maximized.

The field of view distortion detection and adjustment process according to an embodiment of the present disclosure can be organically linked with a traffic-related video analysis solution, as it can be utilized to identify the cause of missing values and/or outliers (e.g., outlier values) in traffic data collected in the future or to correct traffic data on an hourly basis, by delivering field of view distortion information for a camera to a video analysis solution.

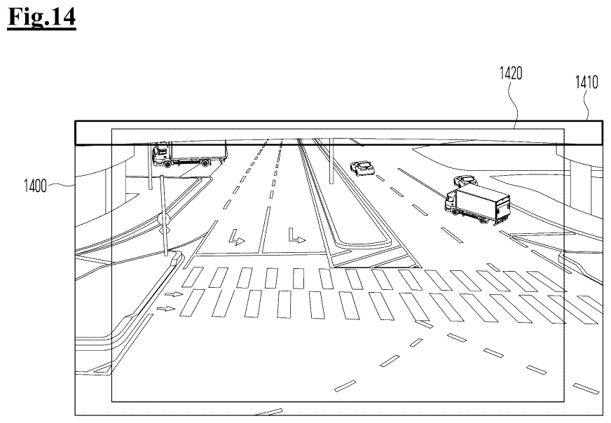

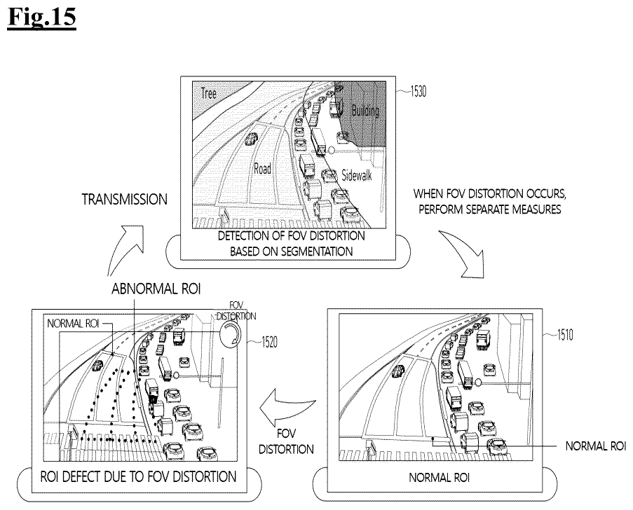

FIG. 14 shows an exemplary screen comparing a restored target image 1400 and a region of interest 1420, according to an embodiment of the present disclosure.

As illustrated in FIG. 14, the restored target image 1400 may represent a result in which the angle for the target image has been adjusted by applying a transformation matrix to the target image. Because the restored target image 1400 changes the position of the pixels of the target image according to an Affine transformation matrix, a noise region (e.g., a black region or a margin region) 1410 due to this change may be generated. This noise region may be determined, for example, by detecting pixels that have no pixel value, have a Null value, or represent black color.

When adjusting the field of view distortion for a target camera, the received target image is restored and a noise region 1410 like that of the restored target image 1400 is generated, and therefore, it can affect or impact the detection and/or monitoring performance of the intelligent control system according to the position and size of the noise region 1410.

A technique according to an embodiment of the present disclosure can determine whether the noise region 1420 generated by the restoration of the target image impacts the performance in an intelligent transportation system, by detecting a noise region 1420 within a restored target image 1400 and by comparing the noise region 1420 with a region of interest predefined for the target camera and/or the target image. For example, the computing device 100, as in the example of FIG. 14, in a case where the noise region 1420 overlaps with at least a part of the region of interest 1410, may determine that there is a possibility of performance degradation of the intelligent transportation system due to the noise region 1420.

In a case where the noise region 1420 overlaps with at least a part of the region of interest 1410, the computing device 100 may determine that the field of view distortion of the target camera is a large distortion. In a case where the noise region 1420 does not overlap with the region of interest 1410, the computing device 100 may determine that the field of view distortion of the target camera is a small distortion.

In a case where the noise region 1420 overlaps with at least a part of the region of interest 1410, the computing device 100 may generate a notification to be delivered to a user. In this case, the restoration accuracy of the restored target image 1400 is not evaluated. In a case where the computing device 100 determines that the noise region 1420 does not overlap with the region of interest 1410, it may evaluate the restoration accuracy of the restored target image 1400. The computing device 100, according to the evaluation result for the restoration accuracy of the restored target image 1400, may deliver a notification with content that proposes resetting the region of interest for the target image to a user and/or with content that proposes an adjustment or correction result or method for the target image.

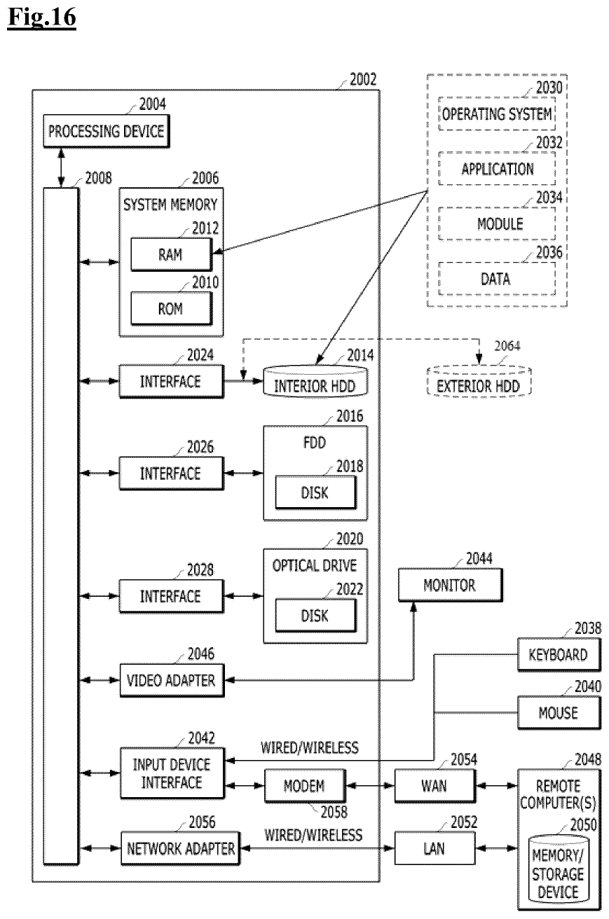

FIG. 15 schematically shows an exemplary process for detecting and processing an abnormal region of interest, in a case where the abnormal region of interest has occurred due to a distortion of a field of view, according to an embodiment of the present disclosure.

As illustrated in reference numeral 1510, a reference image 1510, which is an image in a state where no field of view distortion exists for a target camera, may be obtained. As illustrated in reference numeral 1520, a field of view distortion of the target camera exists due to the influence of exposure to the target camera's external environment, and accordingly, in the target image 1520, the region of interest to be targeted is misaligned or distorted compared to the reference image 1510. In a state where the region of interest is misaligned or distorted, monitoring of the desired performance in the intelligent control system cannot be achieved.

A technique according to an embodiment of the present disclosure, as illustrated in reference numeral 1530, can detect whether a field of view distortion exists in a target image 1520 and/or the distortion type of a field of view by utilizing segmentation technology, and can dynamically apply a process for adjusting the field of view distortion according to this detection result.

Image-based sensors may be vulnerable to field of view distortion without continuous maintenance, because they are directly affected by exposure to the external environment (rain, snowfall, or wind, etc.). If human resources are invested in this maintenance, considerable costs may be incurred in operating the intelligent control system. Furthermore, in the case of a PTZ camera, due to the characteristic that the field of view can be moved by remote control for Zoom and up, down, left, and right directions, there may be a problem that it cannot properly return to the original field of view when manipulated and utilized for control purposes as well as for AI video detection. A problem may occur where it cannot return to the existing preset due to a PTZ camera hardware issue or an administrator's human error, after a user has used the Pan, Tilt, and Zoom functions for control purposes and should return to the existing preset. Furthermore, due to the occurrence of optical axis and motor backlash from camera aging, there may be a problem where the camera cannot return to its original field of view even if a command to return to a preset is given. A technique according to an embodiment of the present disclosure can efficiently solve various problems as above by automating the analysis of field of view distortion and dynamically linking the adjustment process for the field of view distortion accordingly, and thereby, a technical effect can be achieved in that high performance and cost efficiency of an intelligent control system can be achieved.

In an embodiment, a technical effect can be achieved in that a decrease in the image analysis performance in an intelligent control system can be prevented, because the intelligent control system can automatically correct a target image (e.g., an input image) according to distortion information of a target camera and/or automatically correct a region of interest set in the target image, for example, through an artificial intelligence model or an application using an artificial intelligence model.

In an embodiment, the computing device 100 may provide quantitative information of a field of view distortion to a user, and provide a new setting to the user that automatically corrects a setting (e.g., a region of interest setting, etc.) based on the changed field of view. In response to the user making additional modifications to the new setting or confirming the new setting, the computing device 100 may reset an image having the changed field of view (e.g., a restored target image, a replaced target image) as a reference image.

FIG. 16 is a schematic view of a computing environment of the computing device 100 according to an exemplary embodiment of the present disclosure.

In the present disclosure, the component, the module, or the unit includes a routine, a procedure, a program, a component, and a data structure that perform a specific task or implement a specific abstract data type. Further, it will be well appreciated by those skilled in the art that the methods presented by the present disclosure can be implemented by other computer system configurations including a personal computer, a handheld computing device, microprocessor-based or programmable home appliances, and others (the respective devices may operate in connection with one or more associated devices) as well as a single-processor or multi-processor computing device, a mini computer, and a main frame computer.

The embodiments described in the present disclosure may also be implemented in a distributed computing environment in which predetermined tasks are performed by remote processing devices connected through a communication network. In the distributed computing environment, the program module may be positioned in both local and remote memory storage devices.

The computing device generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media.

The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable instruction, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 2000 that implements various aspects of the present disclosure including a computer 2002 is shown and the computer 2002 includes a processing device 2004, a system memory 2006, and a system bus 2008. The computer 200 in the present disclosure may be used intercompatibly with the computer device 100. The system bus 2008 connects system components including the system memory 2006 (not limited thereto) to the processing device 2004. The processing device 2004 may be a predetermined processor among various commercial processors. A dual processor and other multi-processor architectures may also be used as the processing device 2004.

The system bus 2008 may be any one of several types of bus structures which may be additionally interconnected to a local bus using any one of a memory bus, a peripheral device bus, and various commercial bus architectures. The system memory 2006 includes a read only memory (ROM) 2010 and a random access memory (RAM) 2012. A basic input/output system (BIOS) is stored in the non-volatile memories 2010 including the ROM, the EPROM, the EEPROM, and the like and the BIOS includes a basic routine that assists in transmitting information among components in the computer 2002 at a time such as in-starting. The RAM 2012 may also include a high-speed RAM including a static RAM for caching data, and the like.

The computer 2002 also includes an internal hard disk drive (HDD) 2014 (for example, EIDE and SATA), an external hard disk drive (e.g., USB, Thunderbolt and/or eSATA) 2064, a magnetic floppy disk drive (FDD) 2016 (for example, for reading from or writing in a mobile diskette 2018), SSD and an optical disk drive 2020 (for example, for reading a CD-ROM disk 2022 or reading from or writing in other high-capacity optical media such as the DVD). The hard disk drive 2014, the magnetic disk drive 2016, and the optical disk drive 2020 may be connected to the system bus 2008 by a hard disk drive interface 2024, a magnetic disk drive interface 2026, and an optical drive interface 2028, respectively. An interface 2024 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 2002, the drives and the media correspond to storing of predetermined data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 2030, one or more application programs 2032, other program module 2034, and program data 2036 may be stored in the drive and the RAM 2012. All or some of the operating system, the application, the module, and/or the data may also be cached in the RAM 2012. It will be well appreciated that the present disclosure may be implemented in operating systems which are commercially usable or a combination of the operating systems.

A user may input instructions and information in the computer 2002 through one or more wired/wireless input devices, for example, pointing devices such as a keyboard 2038 and a mouse 2040. Other input devices (not illustrated) may include a microphone, an IR remote controller, a joystick, a game pad, a stylus pen, a touch screen, and others. These and other input devices are often connected to the processing device 2004 through an input device interface 2042 connected to the system bus 2008, but may be connected by other interfaces including a parallel port, an IEEE 1394 serial port, a game port, a USB port, an IR interface, and others.

A monitor 2044 or other types of display devices are also connected to the system bus 2008 through interfaces such as a video adapter 2046, and the like. In addition to the monitor 2044, the computer generally includes a speaker, a printer, and other peripheral output devices (not illustrated).

The computer 2002 may operate in a networked environment by using a logical connection to one or more remote computers including remote computer(s) 2048 through wired and/or wireless communication. The remote computer(s) 2048 may be a workstation, a server computer, a router, a personal computer, a portable computer, a micro-processor based entertainment apparatus, a peer device, or other general network nodes and generally includes multiple components or all of the components described with respect to the computer 2002, but only a memory storage device 2050 is illustrated for brief description. The illustrated logical connection includes a wired/wireless connection to a local area network (LAN) 2052 and/or a larger network, for example, a wide area network (WAN) 2054. The LAN and WAN networking environments are general environments in offices and companies and facilitate an enterprise-wide computer network such as Intranet, and all of them may be connected to a worldwide computer network, for example, the Internet.

When the computer 2002 is used in the LAN networking environment, the computer 2002 is connected to a local network 2052 through a wired and/or wireless communication network interface or an adapter 2056. The adapter 2056 may facilitate the wired or wireless communication to the LAN 2052 and the LAN 2052 also includes a wireless access point installed therein in order to communicate with the wireless adapter 2056. When the computer 2002 is used in the WAN networking environment, the computer 2002 may include a modem 2058, is connected to a communication server on the WAN 2054, or has other means that configure communication through the WAN 2054 such as the Internet, etc. The modem 2058 which may be an internal or external and wired or wireless device is connected to the system bus 2008 through the serial port interface 2042. In the networked environment, the program modules described with respect to the computer 2002 or some thereof may be stored in the remote memory/storage device 2050. It will be well known that an illustrated network connection is exemplary and other means configuring a communication link among computers may be used.

The computer 2002 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Method claims provide elements of various steps in a sample order, but the method claims are not limited to the presented specific order or hierarchical structure.

What is claimed is:

1. A method for adjusting a distortion of a field of view (FOV) of a camera in an intelligent transportation system, performed by a computing device, comprising:
receiving a target image captured by a target camera;
generating a first extraction result by extracting a predefined target object within the target image from the target image, and generating a second extraction result by extracting the target object within a reference image from the reference image assigned to the target camera;
generating a first comparison result between the first extraction result and the second extraction result;
determining whether a distortion of the field of view of the target camera exists, using the first comparison result and a predefined threshold;
when it is determined that the distortion of the field of view of the target camera exists, determining a distortion type of the field of view of the target camera, using the first comparison result; and
adjusting the distortion of the field of view of the target camera by using a different field of view adjustment scheme according to the distortion type of the target camera.

2. The method of claim 1, further comprising:
receiving a plurality of sample images captured by the target camera;
generating verification results corresponding to the plurality of sample images, by using one sample image of the plurality of sample images and the remaining sample images other than the one sample image among the plurality of sample images, wherein one verification result is generated for one sample image; and
determining the reference image corresponding to the target camera among the plurality of sample images, by using the verification results.

3. The method of claim 2, wherein the generating of the verification results comprises:
generating third extraction results by extracting the target object from each of the plurality of sample images, using an artificial intelligence model to which each of the plurality of sample images is input; and
generating the verification results corresponding to the plurality of sample images by calculating, for each of the plurality of sample images, a distortion magnitude with other sample images, in a manner of comparing one extraction result corresponding to one sample image among the third extraction results with each of the remaining extraction results corresponding to the remaining sample images other than the one sample image.

4. The method of claim 3, wherein the determining of the reference image among the plurality of sample images by using the verification results comprises:
determining a sample image corresponding to a verification result with the smallest distortion magnitude among the verification results as the reference image corresponding to a region of interest (ROI) of the target camera.

5. The method of claim 3, wherein among the third extraction results, sample images having an extraction result where a ratio of an area occupied by the target object within the image is smaller than a predetermined threshold ratio are excluded from the generating the verification results.

6. The method of claim 1, wherein the generating of the first comparison result between the first extraction result and the second extraction result comprises:
detecting target feature points from the first extraction result and detecting reference feature points from the second extraction result; and
generating the first comparison result including first transformation information that represents a distortion between the target image and the reference image, by matching the target feature points and the reference feature points;
wherein the determining of whether the distortion of the field of view of the target camera exists comprises, determining that the distortion of the field of view of the target camera exists, when the first transformation information is greater than the predefined threshold; and
wherein the determining of the distortion type of the field of view of the target camera using the first comparison result comprises, determining the distortion type of the field of view of the target camera based on the first transformation information.

7. The method of claim 6, wherein the determining of the distortion type of the field of view of the target camera based on the first transformation information comprises:
generating a restored target image by applying a transformation matrix included in the first transformation information to the target image so that the target image is matched to the reference image; and
determining the distortion type of the field of view of the target camera, by using the restored target image.

8. The method of claim 7, wherein the determining of the distortion type of the field of view of the target camera by using the restored target image comprises,
determining whether the distortion type of the field of view of the target camera is a first type corresponding to a large distortion or a second type corresponding to a small distortion, by using a size of a noise region generated in a process of restoring the target image within the restored target image.

9. The method of claim 7, wherein the determining of the distortion type of the field of view of the target camera by using the restored target image comprises,
obtaining a region of interest set for the target camera; and
determining whether the distortion type of the field of view of the target camera is a first type corresponding to a large distortion or a second type corresponding to a small distortion, based on whether an overlapping portion exists between the obtained region of interest and a noise region generated in a process of transforming the target image.

10. The method of claim 7, further comprising:
determining a pixel accuracy for the restored target image by comparing, at a pixel level, a first pixel set representing the target object in the restored target image and a second pixel set representing the target object in the reference image; and
evaluating a restoration accuracy of the restored target image by using the pixel accuracy.

11. The method of claim 7, further comprising:
detecting restored target feature points representing the target object in the restored target image and detecting the reference feature points from the second extraction result;
generating a second comparison result including second transformation information that represents a distortion between the restored target image and the reference image, by matching the restored target feature points and the reference feature points; and
evaluating a restoration accuracy of the restored target image by using the second transformation information.

12. The method of claim 7, wherein the distortion type includes a first type corresponding to a large distortion and a second type corresponding to a small distortion,
wherein the adjusting of the distortion of the field of view of the target camera comprises:
evaluating a restoration accuracy of the restored target image when the distortion type is determined as the second type; and
adjusting the distortion of the field of view of the target camera by replacing the target image with the restored target image, when the restoration accuracy exceeds a predetermined threshold accuracy; and
wherein the evaluating of the restoration accuracy is not performed when the distortion type is determined as the first type.

13. The method of claim 1, wherein the determining whether the distortion of the field of view of the target camera exists using the first comparison result and the predefined threshold comprises:
providing a plurality of sample images received from the target camera to a user;
receiving a classification result, in which the user visually classifies each of the plurality of sample images as either a first sample image without a distortion of a field of view or a second sample image with a distortion of a field of view; and
determining the predefined threshold by using transformation matrices of the sample images with respect to the reference image and the classification result.

14. The method of claim 1, wherein the adjusting the distortion of the field of view of the target camera by using a different field of view adjustment scheme according to the distortion type of the target camera comprises:
adjusting the distortion of the field of view of the target camera by controlling a physical movement of the target camera or generating a notification for an operator, when the distortion type is determined as a first type corresponding to a large distortion, and adjusting the distortion of the field of view of the target camera by performing a field of view correction process on the target image, when the distortion type is determined as a second type corresponding to a small distortion; or
adjusting the distortion of the field of view of the target camera by controlling the physical movement of the target camera or generating the notification for the operator, when the distortion type is determined as the first type corresponding to a large distortion, and adjusting the distortion of the field of view of the target camera by generating a restored target image corresponding to the target image, when the distortion type is determined as the second type corresponding to a small distortion.

15. The method of claim 1, wherein the target object corresponds to a road object,
the target object is extracted by using an artificial intelligence model pretrained to output a road region corresponding to the road object within an input image, and
in the first extraction result and the second extraction result, remaining regions other than the road object are masked.

16. The method of claim 1, further comprising:
after the determining of the distortion type of the field of view of the target camera, generating an adjusted region of interest for the target camera, by using the first comparison result;
providing the adjusted region of interest to a user; and
resetting the target image as the reference image, in response to setting, by the user, the adjusted region of interest or a partially adjusted version of the adjusted region of interest as the region of interest for the target camera.

17. The method of claim 16, wherein the distortion type of the target camera includes a first type corresponding to a large distortion and a second type corresponding to a small distortion,
the generating of the adjusted region of interest is performed by using an artificial intelligence model to which a pre-set region of interest for the target camera and the first comparison result are input and from which the adjusted region of interest is output, and
the generating of the adjusted region of interest is performed when the distortion type is the second type, and is not performed when the distortion type is the first type.

18. The method of claim 1, wherein the distortion type includes a first type corresponding to a large distortion and a second type corresponding to a small distortion,
the adjusting of the distortion of the field of view of the target camera is repeatedly performed for each of periodically received target images in response to the distortion type being determined to be a second type, and is characterized by adjusting the distortion of the field of view of the target camera by replacing each of the target images by using a restored target image generated by applying the first comparison result to each of the target images, and
the method further comprises:
generating an adjusted region of interest for the target camera by using the first comparison result, in response to the distortion type being determined as the second type; and
terminating the repeatedly performed adjustment of the distortion of the field of view, in response to a region of interest for the target camera being reset based on the adjusted region of interest.

19. A computer program stored in a non-transitory computer readable medium, wherein the computer program allows at least one processor of a computing device to perform a method for adjusting a distortion of a field of view of a camera in an intelligent transportation system, and wherein the method comprise:
receiving a target image captured by a target camera;
generating a first extraction result by extracting a predefined target object within the target image from the target image, and generating a second extraction result by extracting the target object within a reference image from the reference image assigned to the target camera;
generating a first comparison result between the first extraction result and the second extraction result;
determining whether a distortion of the field of view of the target camera exists, using the first comparison result and a predefined threshold;
when it is determined that the distortion of the field of view of the target camera exists, determining a distortion type of the field of view of the target camera, using the first comparison result; and
adjusting the distortion of the field of view of the target camera by using a different field of view adjustment scheme according to the distortion type of the target camera.

20. A computing device for adjusting a distortion of a field of view of a camera in an intelligent transportation system, comprising:
at least one processor; and
a memory,
wherein the at least one processor:
receives a target image captured by a target camera;
generates a first extraction result by extracting a predefined target object within the target image from the target image, and generates a second extraction result by extracting the target object within a reference image from the reference image assigned to the target camera;
generates a first comparison result between the first extraction result and the second extraction result;
determines whether a distortion of the field of view of the target camera exists, using the first comparison result and a predefined threshold;
when it is determined that the distortion of the field of view of the target camera exists, determines a distortion type of the field of view of the target camera, using the first comparison result; and
adjust the distortion of the field of view of the target camera by using a different field of view adjustment scheme according to the distortion type of the target camera.
